(19) United States
(12) Patent Application Publication
(10) Pub. No.: US 2025/0389934 A1
(43) Pub. Date: Dec. 25, 2025

(54) IMAGING LENS AND IMAGING APPARATUS

(71) Applicant: FUJIFILM Corporation, Tokyo (JP)

(72) Inventors: Yuya HIRAKAWA, Saitama (JP); Shunsuke MIYAGISHIMA, Saitama (JP); Ryoko TOMIOKA, Saitama (JP); Hiroki SAITO, Saitama (JP)

(73) Assignee: FUJIFILM Corporation, Tokyo (JP)

(21) Appl. No.: 19/237,194

(22) Filed: Jun. 13, 2025

(30) Foreign Application Priority Data
Jun. 25, 2024 (JP) 2024-102347

(51) Int. Cl. G02B 13/00

(52) U.S. Cl. CPC G02B 13/0045; G02B 13/006

(57) ABSTRACT

An imaging lens consists of, in order from an object side to an image side, a first lens group, a second lens group, and a third lens group. During focusing, the first lens group and the third lens group are fixed with respect to an image plane and the second lens group moves along an optical axis. A stop that is fixed with respect to the image plane during focusing is disposed on the object side with respect to the second lens group. The first lens group includes a first negative lens of which an image side surface is a concave surface, at a position closest to the object side. The imaging lens satisfies a predetermined conditional expression.

### CROSS-REFERENCE TO RELATED APPLICATIONS

This application claims priority from Japanese Patent Application No. 2024-102347, filed on Jun. 25, 2024, the entire disclosure of which is incorporated herein by reference.

### BACKGROUND

### Technical Field

The technology of the present disclosure relates to an imaging lens and an imaging apparatus.

### Related Art

In the related art, lens systems according to JP2021-148887A and JP2020-177110A have been known as an imaging lens used in a digital camera and the like.

### SUMMARY

There is a demand for an imaging lens having a small F-number, a more compact configuration, and favorably corrected aberrations.

The present disclosure provides an imaging lens having a small F-number, a more compact configuration, and favorably corrected aberrations, and an imaging apparatus comprising the imaging lens.

An aspect of the technology of the present disclosure relates to an imaging lens consisting of, in order from an object side to an image side, a first lens group, a second lens group, and a third lens group, in which during focusing, the first lens group and the third lens group are fixed with respect to an image plane and the second lens group moves along an optical axis, a stop that is fixed with respect to the image plane during focusing is disposed on the object side with respect to the second lens group, the first lens group includes a first negative lens of which an image side surface is a concave surface, at a position closest to the object side, and the imaging lens satisfies Conditional Expressions (1) and (2), which are represented by 2<TL/(f×tan ωm) <5.5(1), and 4<TL×FNo/f<7.5(2).

Here, a sum of a distance, on the optical axis, from a lens surface of the first lens group closest to the object side to a lens surface of the third lens group closest to the image side and a back focus of an entire system at an air conversion distance, in a state in which an infinite distance object is in focus, is denoted by TL. A focal length of the entire system in a state in which the infinite distance object is in focus is denoted by f. A maximum half angle of view in a state in which the infinite distance object is in focus is denoted by ωm. An open F-number in a state in which the infinite distance object is in focus is denoted by FNo.

In a case in which a focal length of the second lens group is denoted by f2, it is preferable that the imaging lens according to the above-described aspect satisfies Conditional Expression (3), which is represented by 0.2<f/|f2|<3(3).

In a case in which a distance, on the optical axis, from a lens surface of the imaging lens closest to the object side to a paraxial entrance pupil position in a state in which the infinite distance object is in focus is denoted by Enp, it is preferable that the imaging lens according to the above-described aspect satisfies Conditional Expression (4), which is represented by 1.5<f/Enp<6(4).

In a configuration in which at least one of the first negative lens of the first lens group or a lens disposed adjacent to the image side of the first negative lens includes an aspherical surface, in a case in which an air spacing, on the optical axis, between the first negative lens of the first lens group and the lens disposed adjacent to the image side of the first negative lens is denoted by DL12, it is preferable that the imaging lens according to the above-described aspect satisfies Conditional Expression (5), which is represented by 0.015<DL12/TL<0.25(5).

In a configuration in which a positive lens is disposed adjacent to the object side of the stop, in a case in which a refractive index of the positive lens disposed adjacent to the object side of the stop at a d line is denoted by Nsf, it is preferable that the imaging lens according to the above-described aspect satisfies Conditional Expression (6), which is represented by 1.7<Nsf<2.2(6).

In a case in which a lateral magnification of the second lens group in a state in which the infinite distance object is in focus is denoted by β2, and a lateral magnification of the third lens group in a state in which the infinite distance object is in focus is denoted by β3, it is preferable that the imaging lens according to the above-described aspect satisfies Conditional Expression (7), which is represented by 0.8<|(1-β2²)×β² 32|<5(7).

It is preferable that the first lens group includes at least two negative lenses and at least one positive lens.

In a case in which an average value of refractive indexes of all negative lenses included in the first lens group at a d line is denoted by N1nave, it is preferable that the imaging lens according to the above-described aspect satisfies Conditional Expression (8), which is represented by 1.555<N1nave<1.9(8).

In a case in which the back focus of the entire system at the air conversion distance in a state in which the infinite distance object is in focus is denoted by Bf, it is preferable that the imaging lens according to the above-described aspect satisfies Conditional Expression (9), which is represented by 0.4<Bf/(f×tan ωm)<2.5(9).

In a case in which a thickness of the second lens group on the optical axis is denoted by DG2, it is preferable that the imaging lens according to the above-described aspect satisfies Conditional Expression (10), which is represented by 0.01<DG2/TL<0.4(10).

In a case in which a maximum value of refractive indexes of all lenses included in the imaging lens at a d line is denoted by Nmax, it is preferable that the imaging lens according to the above-described aspect satisfies Conditional Expression (11), which is represented by 1.8<Nmax<2.2(11).

In a case in which an average value of refractive indexes of all positive lenses included in the imaging lens at a d line is denoted by Npave, it is preferable that the imaging lens according to the above-described aspect satisfies Conditional Expression (12), which is represented by 1.64<Npave <1.88(12).

In a case in which a focal length of the first negative lens of the first lens group is denoted by fL1, it is preferable that the imaging lens according to the above-described aspect satisfies Conditional Expression (13), which is represented by−2<f/fL1<−0.45(13).

In a case in which a distance, on the optical axis, from the image plane to a paraxial exit pupil position in a state in which the infinite distance object is in focus is denoted by Exp, a sign of Exp is defined such that, with the image plane as a reference, a distance in a direction from the image plane to the object side is negative and a distance in a direction from the object side to the image side is positive, and in a case in which an optical member having no refractive power is disposed between the image plane and the paraxial exit pupil position, Exp is calculated using an air conversion distance for the optical member, it is preferable that the imaging lens according to the above-described aspect satisfies Conditional Expression (14), which is represented by−5<Exp/(f×tan ωm)<−1.4(14).

In a configuration in which the second lens group has a positive refractive power, and the third lens group has a negative refractive power, in a case in which a focal length of the first lens group is denoted by f1, it is preferable that the imaging lens according to the above-described aspect satisfies Conditional Expression (15), which is represented by−1.5<f/f1<1.5 (15).

In a configuration in which the second lens group has a positive refractive power, and the third lens group has a negative refractive power, in a case in which a focal length of the second lens group is denoted by f2, and a focal length of the third lens group is denoted by f3, it is preferable that the imaging lens according to the above-described aspect satisfies Conditional Expression (16), which is represented by−1.1<f2/f3<−0.07 (16).

In a configuration in which the second lens group has a positive refractive power, and the third lens group has a negative refractive power, in a case in which a focal length of the third lens group is denoted by f3, it is preferable that the imaging lens according to the above-described aspect satisfies Conditional Expression (17), which is represented by−1.1<f/f3<−0.03 (17).

In a configuration in which the second lens group has a negative refractive power, and the third lens group has a positive refractive power, in a case in which a focal length of the first lens group is denoted by f1, it is preferable that the imaging lens according to the above-described aspect satisfies Conditional Expression (15A), which is represented by 1<f/f1<3 (15A).

In a configuration in which the second lens group has a negative refractive power, and the third lens group has a positive refractive power, in a case in which a focal length of the third lens group is denoted by f3, it is preferable that the imaging lens according to the above-described aspect satisfies Conditional Expression (17A), which is represented by 0.1<f/f3<0.7 (17A).

Another aspect of the present disclosure relates to an imaging apparatus comprising the imaging lens according to the above-described aspect.

It should be noted that, in the present specification, the expressions“consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituents.

The expressions“ . . . group having a positive refractive power” and“ . . . group has a positive refractive power” in the present specification mean that the entire group has a positive refractive power. Similarly, the expressions“ . . . group having a negative refractive power” and “ . . . group has a negative refractive power” mean that the entire group has a negative refractive power. The expressions“lens having a positive refractive power” and“positive lens” are synonymous. The expressions“lens having a negative refractive power” and“negative lens” are synonymous. The expression“ . . . group” in the present specification is not limited to a configuration consisting of a plurality of lenses and may be a configuration consisting of only one lens.

A compound aspherical lens (a lens in which a lens (for example, a spherical lens) and a film of an aspherical shape formed on the lens are integrally formed and that functions as one aspherical lens as a whole) is not regarded as a cemented lens and is regarded as one lens. Unless otherwise noted, a curvature radius, a sign of a refractive power, and a surface shape related to a lens including an aspherical surface in a paraxial region are used. A sign of the curvature radius is defined such that a sign of the curvature radius of a surface having a convex shape facing the object side is positive, and a sign of the curvature radius of a surface having a convex shape facing the image side is negative.

In the present specification, the expression“entire system” refers to an“imaging lens”. The expression“focal length” used in the conditional expressions means a paraxial focal length. Unless otherwise noted, the expression“distance on the optical axis” used in the conditional expressions means a geometrical distance. Unless otherwise noted, values used in the conditional expressions are values based on a d line in a state in which the infinite distance object is in focus.

The“d line”, a“C line”, and an“Fline” described in the present specification are emission lines, a wavelength of the d line is 587.56 nanometers (nm), a wavelength of the C line is 656.27 nanometers (nm), and a wavelength of the F line is 486.13 nanometers (nm).

According to the present disclosure, it is possible to provide the imaging lens having a small F-number, a more compact configuration, and favorably corrected aberrations, and the imaging apparatus comprising the imaging lens.

### BRIEF DESCRIPTION OF THE DRAWINGS

FIG. 1 is a cross-sectional view showing a configuration of an imaging lens according to one embodiment, which corresponds to an imaging lens according to Example 1.

FIG. 2 is a cross-sectional view showing a configuration and a luminous flux in each state of the imaging lens in FIG. 1.

FIG. 3 is a diagram showing symbols of a conditional expression.

FIG. 4 is each aberration diagram of the imaging lens according to Example 1.

FIG. 5 is a cross-sectional view showing a configuration of an imaging lens according to Example 2.

FIG. 6 is each aberration diagram of the imaging lens according to Example 2.

FIG. 7 is a cross-sectional view showing a configuration of an imaging lens according to Example 3.

FIG. 8 is each aberration diagram of the imaging lens according to Example 3.

FIG. 9 is a cross-sectional view showing a configuration of an imaging lens according to Example 4.

FIG. 10 is each aberration diagram of the imaging lens according to Example 4.

FIG. 11 is a cross-sectional view showing a configuration of an imaging lens according to Example 5.

FIG. 12 is each aberration diagram of the imaging lens according to Example 5.

FIG. 13 is a cross-sectional view showing a configuration of an imaging lens according to Example 6.

FIG. 14 is each aberration diagram of the imaging lens according to Example 6.

FIG. 15 is a cross-sectional view showing a configuration of an imaging lens according to Example 7.

FIG. 16 is each aberration diagram of the imaging lens according to Example 7.

FIG. 17 is a cross-sectional view showing a configuration of an imaging lens according to Example 8.

FIG. 18 is each aberration diagram of the imaging lens according to Example 8.

FIG. 19 is a cross-sectional view showing a configuration of an imaging lens according to Example 9.

FIG. 20 is each aberration diagram of the imaging lens according to Example 9.

FIG. 21 is a cross-sectional view showing a configuration of an imaging lens according to Example 10.

FIG. 22 is each aberration diagram of the imaging lens according to Example 10.

FIG. 23 is a cross-sectional view showing a configuration of an imaging lens according to Example 11.

FIG. 24 is each aberration diagram of the imaging lens according to Example 11.

FIG. 25 is a cross-sectional view showing a configuration of an imaging lens according to Example 12.

FIG. 26 is each aberration diagram of the imaging lens according to Example 12.

FIG. 27 is a cross-sectional view showing a configuration of an imaging lens according to Example 13.

FIG. 28 is each aberration diagram of the imaging lens according to Example 13.

FIG. 29 is a perspective view of a front surface side of an imaging apparatus according to one embodiment.

FIG. 30 is a perspective view of a rear surface side of the imaging apparatus according to the embodiment.

### DETAILED DESCRIPTION

Hereinafter, an embodiment of the technology of the present disclosure will be described with reference to the drawings.

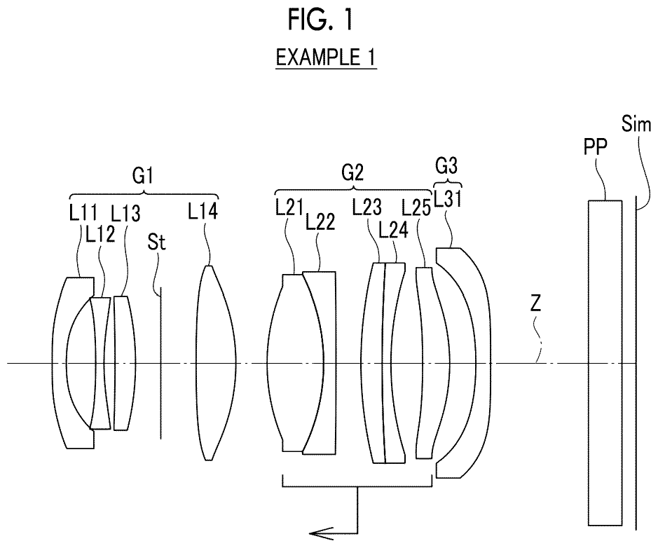

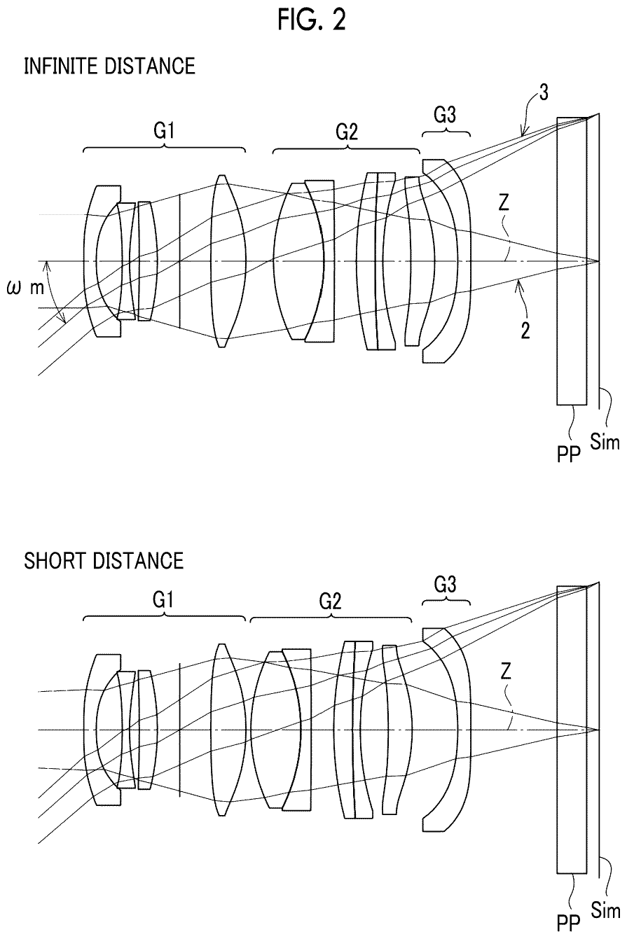

FIG. 1 shows a cross-sectional view of a configuration of an imaging lens according to one embodiment of the present disclosure, in a state in which an infinite distance object is in focus. FIG. 2 shows a cross-sectional view of the configuration and the luminous flux of the imaging lens in FIG. 1 in each focus state. In FIG. 2, the upper part labeled“infinite distance” shows a state in which the infinite distance object is in focus, and the lower part labeled“short distance” shows a state in which a short distance object is in focus. FIG. 2 shows, as luminous fluxes, an on-axis luminous flux 2 and a luminous flux 3 having a maximum half angle of view ωm in a state in which the infinite distance object is in focus, and an on-axis luminous flux and a luminous flux having a maximum half angle of view in a state in which the short distance object is in focus. In FIGS. 1 and 2, a left side is an object side, and a right side is an image side. The examples shown in FIGS. 1 and 2 correspond to an imaging lens according to Example 1 described later. Hereinafter, the description will be made mainly with reference to FIG. 1.

FIG. 1 shows an example in which an optical member PP having a parallel flat plate shape is disposed between the imaging lens and an image plane Sim, assuming that the imaging lens is applied to an imaging apparatus. The optical member PP is a member assumed to be various filters and/or a cover glass. The various filters include a low-pass filter, an infrared cut filter, and/or a filter or the like that cuts a specific wavelength range. The optical member PP is a member having no refractive power. The imaging apparatus can also be configured without using the optical member PP.

The imaging lens according to the present disclosure consists of, in order from the object side to the image side along an optical axis Z, a first lens group G1, a second lens group G2, and a third lens group G3. During focusing, the second lens group G2 moves along the optical axis Z, and the first lens group G1 and the third lens group G3 are fixed with respect to the image plane Sim. By fixing the first lens group G1 during focusing, the total length is not changed even during focusing, so that it is possible to prevent the lens from being too close to the subject during close-up imaging, and thus a lens system having high convenience can be obtained. In addition, by fixing the first lens group G1 and the third lens group G3 during focusing, there is an advantage in dustproof and waterproof structures.

As an example, each group of the imaging lens in FIG. 1 is formed as follows. The first lens group G1 consists of, in order from the object side to the image side, lenses L11 to L13, an aperture stop St, and a lens L14. The second lens group G2 consists of, in order from the object side to the image side, five lenses, that is, lenses L21 to L25. The third lens group G3 consists of one lens, that is, the lens L31. It should be noted that the aperture stop St in FIG. 1 does not indicate a size or a shape and indicates a position in an optical axis direction.

In the present specification, a group that moves along the optical axis Z during focusing will be referred to as a“focusing group”. In the imaging lens according to the present disclosure, the focusing group consists of only the second lens group G2. In FIG. 1, a horizontal arrow indicating a movement direction during focusing from the infinite distance object to the short distance object is shown below the focusing group. The parentheses and the leftward arrow below the second lens group G2 in FIG. 1 indicate that the second lens group G2 is the focusing group and that the second lens group G2 moves to the object side during focusing from the infinite distance object to the short distance object.

In the imaging lens according to the present disclosure, a stop that is fixed with respect to the image plane Sim during focusing is disposed on the object side with respect to the second lens group G2. By configuring the focusing group not to include the stop, the focusing group can be reduced in weight, so that there is an advantage in achieving an increase in speed of focusing, and there is an advantage in achieving reduction in size of the entire lens device. In the example of FIG. 1, the aperture stop St as the stop is disposed in the first lens group G1.

In the imaging lens according to the present disclosure, the first lens group G1 includes a first negative lens of which an image side surface is a concave surface, at a position closest to the object side. With this configuration, the occurrence of astigmatism can be suppressed. In the example of FIG. 1, the lens L11 corresponds to a first negative lens.

It is preferable that the object side surface of the first negative lens is a convex surface. In this case, there is an advantage in correcting astigmatism that is likely to occur in a case of increasing the angle of view.

It is preferable that at least one of the first negative lens or a lens disposed adjacent to the image side of the first negative lens includes an aspherical surface. In a case in which such a configuration is adopted, there is an advantage in the field curvature correction.

It is preferable that the air lens of the imaging lens closest to the object side has a biconvex shape. For example, in a case of a single lens to which the first negative lens is not cemented as in the example of FIG. 1, it is preferable that an air spacing between the image side surface of the first negative lens and the object side surface of the lens disposed adjacent to the image side of the first negative lens has a biconvex shape. In this case, there is an advantage in correcting distortion and field curvature.

It is preferable that the first lens group G1 includes at least two negative lenses and at least one positive lens. In this case, there is an advantage in correcting lateral chromatic aberration and reducing the F-number.

The number of lenses included in the first lens group G1 may be seven or less. In this case, there is an advantage in satisfactorily correcting the lateral chromatic aberration without increasing the size of the lens system. Further, in a case in which it is desired to suppress an increase in size of the lens system, the number of lenses included in the first lens group G1 is more preferably six or less, still more preferably five or less, and still more preferably four or less.

It is preferable that the second lens group G2 includes at least one negative lens. In a case in which such a configuration is adopted, there is an advantage in the spherical aberration correction.

In a case in which the second lens group G2 has a negative refractive power and the third lens group G3 has a positive refractive power, the second lens group G2 may consist of one negative lens. In this case, the focusing group can be reduced in weight, so that there is an advantage in achieving an increase in speed of focusing.

The number of lenses included in the second lens group G2 may be seven or less. In this case, there is an advantage in suppressing fluctuation in aberration during focusing without increasing the size of the lens system. Further, in a case in which it is desired to suppress an increase in size of the lens system, the number of lenses included in the second lens group G2 is more preferably six or less, still more preferably five or less, and still more preferably four or less.

The number of lenses included in the third lens group G3 may be four or less. In this case, the number of lenses that are close to the image plane Sim and that have a relatively large outer diameter can be suppressed, so that there is an advantage in achieving reduction in weight. In order to further reduce the weight, the number of lenses included in the third lens group G3 is more preferably three or less, and still more preferably two or less.

At least one of the second lens group G2 or the third lens group G3 may include an aspherical lens surface having an inflection point at which a concave-convex shape changes in the middle from the optical axis toward the peripheral portion. In this way, by disposing the aspherical surface at the position at which the off-axis luminous fluxes are separated and further providing the inflection point on the aspherical surface, there is an advantage in correcting the astigmatism.

It should be noted that the“inflection point” is a point at which the surface shape changes from a convex shape to a concave shape or from a concave shape to a convex shape, that is, a point at which a sign of a curvature radius changes. Since the lens surface has the inflection point, the refractive power of the peripheral portion of the lens can be determined without depending on the refractive power in the paraxial region, so that there is an advantage in correcting aberrations.

The number of lenses included in the entire imaging lens may be seven or more. In this case, there is an advantage in favorable correction of lateral chromatic aberration and spherical aberration. In order to obtain more favorable characteristics, the number of lenses included in the entire imaging lens is more preferably eight or more, and still more preferably nine or more.

The number of lenses included in the entire imaging lens may be 13 or less. In this case, there is an advantage in suppressing an increase in size of the entire lens system. In order to further suppress an increase in size of the entire lens system, the number of lenses included in the entire imaging lens is more preferably 12 or less, and still more preferably 11 or less.

Hereinafter, preferred configurations of the imaging lens according to the present disclosure related to conditional expressions will be described. In the following description of the conditional expressions, in order to avoid redundancy, the same symbol will be used for the same definition, and the duplicate description of the symbol will be omitted. Hereinafter, the “imaging lens according to the present disclosure” will be simply referred to as the“imaging lens” in order to avoid redundancy.

It is preferable that the imaging lens satisfies Conditional Expression (1). Here, a sum of a distance on the optical axis from a lens surface of the first lens group G1 closest to the object side to a lens surface of the third lens group G3 closest to the image side and the back focus of the entire system at the air conversion distance, in a state in which the infinite distance object is in focus, is denoted by TL. A focal length of the entire system in a state in which the infinite distance object is in focus is denoted by f. A maximum half angle of view in a state in which the infinite distance object is in focus is denoted by ωm. Here, the unit of ωm is degrees.

As an example, FIG. 2 shows the maximum half angle of view ωm. By not allowing the corresponding value of Conditional Expression (1) to be equal to or less than the lower limit value, there is an advantage in maintaining high optical performance. By not allowing the corresponding value of Conditional Expression (1) to be equal to or greater than the upper limit value, there is an advantage in reduction of the total length of the lens system.

$$2 < TL / ( f \times tan ω m ) < 5.5 \qquad ( 1 )$$

In order to obtain more favorable characteristics, the lower limit value of Conditional Expression (1) is more preferably 2.2, still more preferably 2.3, still more preferably 2.4, and still more preferably 2.5. In order to obtain more favorable characteristics, the upper limit value of Conditional Expression (1) is more preferably 5, still more preferably 4, still more preferably 3.6, and still more preferably 3.5.

In a case in which an open F-number in a state in which the infinite distance object is in focus is denoted by FNo, it is preferable that the imaging lens satisfies Conditional Expression (2). By not allowing the corresponding value of Conditional Expression (2) to be equal to or less than the lower limit value, it is easy to dispose the optimum number of lenses for correcting various aberrations, so that it is easy to obtain higher image formation performance. By not allowing the corresponding value of Conditional Expression (2) to be equal to or greater than the upper limit value, there is an advantage in suppressing an increase in size of the entire lens system, and there is an advantage in reducing the F-number.

$$4 < TL \times FNo / f < 7.5 \qquad ( 2 )$$

In order to obtain more favorable characteristics, the lower limit value of Conditional Expression (2) is more preferably 4.3, still more preferably 4.6, and still more preferably 4.8. In order to obtain more favorable characteristics, the upper limit value of Conditional Expression (2) is more preferably 7, still more preferably 6.5, and still more preferably 6.

In a case in which a focal length of the second lens group G2 is denoted by f2, it is preferable that the imaging lens satisfies Conditional Expression (3). By not allowing the corresponding value of Conditional Expression (3) to be equal to or less than the lower limit value, the movement amount of the second lens group G2 during focusing can be reduced, so that there is an advantage in achieving reduction in total length of the lens system. By not allowing the corresponding value of Conditional Expression (3) to be equal to or greater than the upper limit value, it is possible to suppress fluctuation in spherical aberration and fluctuation in field curvature during focusing.

$$0.2 < f / \vert f 2 \vert < 3 \qquad ( 3 )$$

In order to obtain more favorable characteristics, the lower limit value of Conditional Expression (3) is more preferably 0.25, still more preferably 0.3, still more preferably 0.4, still more preferably 0.45, and still more preferably 0.5. In order to obtain more favorable characteristics, the upper limit value of Conditional Expression (3) is more preferably 2.5, still more preferably 2, still more preferably 1.8, still more preferably 1.5, and still more preferably 1.3.

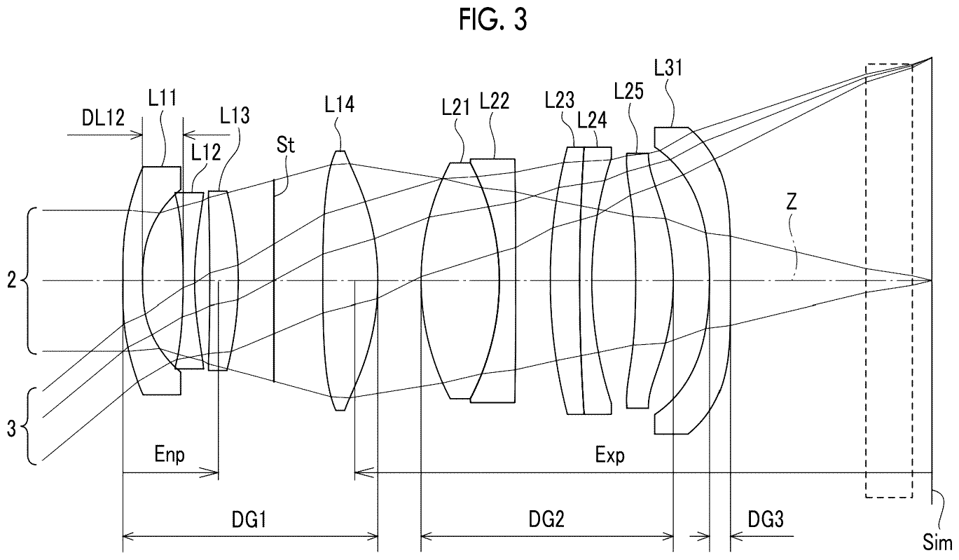

It is preferable that the imaging lens satisfies Conditional Expression (4). Here, a distance, on the optical axis, from a lens surface of the imaging lens closest to the object side to a paraxial entrance pupil position in a state in which the infinite distance object is in focus is denoted by Enp. FIG. 3 shows the imaging lens of FIG. 1 in a state in which the infinite distance object is in focus, and shows the distance Enp as an example. By not allowing the corresponding value of Conditional Expression (4) to be equal to or less than the lower limit value, there is an advantage in achieving reduction in diameter of the components on the object side in the lens system. By not allowing the corresponding value of Conditional Expression (4) to be equal to or greater than the upper limit value, the separation between the on-axis ray and the off-axis ray in the lens on the object side in the lens system is facilitated, so that there is an advantage in correcting various aberrations related to the off-axis ray.

$$1.5 < f / Enp < 6 \qquad ( 4 )$$

In order to obtain more favorable characteristics, the lower limit value of Conditional Expression (4) is more preferably 1.8, still more preferably 2, still more preferably 2.2, still more preferably 2.5, and still more preferably 2.6. In order to obtain more favorable characteristics, the upper limit value of Conditional Expression (4) is more preferably 5, still more preferably 4.5, still more preferably 4, still more preferably 3.8, and still more preferably 3.6.

In a configuration in which at least one of the first negative lens of the first lens group G1 or the lens disposed adjacent to the image side of the first negative lens includes the aspherical surface, it is preferable that the imaging lens satisfies Conditional Expression (5). Here, an air spacing, on the optical axis, between the first negative lens of the first lens group G1 and the lens disposed adjacent to the image side of the first negative lens is denoted by DL12. As an example, FIG. 3 shows the air spacing DL12. By not allowing the corresponding value of Conditional Expression (5) to be equal to or less than the lower limit value, there is an advantage in correcting distortion. By not allowing the corresponding value of Conditional Expression (5) to be equal to or greater than the upper limit value, there is an advantage in suppressing an increase in diameter of the lens on the object side in the lens system.

$$0.015 < DL 12 / TL < 0.25 \qquad ( 5 )$$

In order to obtain more favorable characteristics, the lower limit value of Conditional Expression (5) is more preferably 0.02, still more preferably 0.03, still more preferably 0.04, and still more preferably 0.05. In order to obtain more favorable characteristics, the upper limit value of Conditional Expression (5) is more preferably 0.2, still more preferably 0.15, still more preferably 0.12, and still more preferably 0.1.

In the configuration in which the positive lens is disposed adjacent to the object side of the aperture stop St, it is preferable that the imaging lens satisfies Conditional Expression (6). Here, a refractive index of the positive lens disposed adjacent to the object side of the aperture stop St at the d line is denoted by Nsf. By not allowing the corresponding value of Conditional Expression (6) to be equal to or less than the lower limit value, there is an advantage in shortening the total length. By not allowing the corresponding value of Conditional Expression (6) to be equal to or greater than the upper limit value, there is an advantage in correcting spherical aberration.

$$1.7 < Nsf < 2.2 \qquad ( 6 )$$

In order to obtain more favorable characteristics, the lower limit value of Conditional Expression (6) is more preferably 1.73, still more preferably 1.75, and still more preferably 1.78. In order to obtain more favorable characteristics, the upper limit value of Conditional Expression (6) is more preferably 2.15, still more preferably 2.1, and still more preferably 2.06.

It is preferable that the imaging lens satisfies Conditional Expression (7). Here, a lateral magnification of the second lens group G2 in a state in which the infinite distance object is in focus is denoted by β2. A lateral magnification of the third lens group G3 in a state in which the infinite distance object is in focus is denoted by β3. By not allowing the corresponding value of Conditional Expression (7) to be equal to or less than the lower limit value, the movement amount of the second lens group G2 during focusing can be reduced, so that there is an advantage in achieving reduction in total length of the lens system. By not allowing the corresponding value of Conditional Expression (7) to be equal to or greater than the upper limit value, it is possible to suppress fluctuation in spherical aberration and fluctuation in field curvature during focusing.

$$0.8 < \vert ( 1 - {β2}^{2} ) \times {β3}^{2} \vert < 5 \qquad ( 7 )$$

In order to obtain more favorable characteristics, the lower limit value of Conditional Expression (7) is more preferably 0.85, still more preferably 0.9, still more preferably 0.93, still more preferably 0.95, and still more preferably 0.98. In order to obtain more favorable characteristics, the upper limit value of Conditional Expression (7) is more preferably 4.5, still more preferably 4.3, still more preferably 4, still more preferably 3.5, and still more preferably 3.3.

In a case in which an average value of refractive indexes of all negative lenses included in the first lens group G1 at the d line is denoted by N1nave, it is preferable that the imaging lens satisfies Conditional Expression (8). By not allowing the corresponding value of Conditional Expression (8) to be equal to or less than the lower limit value, there is an advantage in the spherical aberration correction. By not allowing the corresponding value of Conditional Expression (8) to be equal to or greater than the upper limit value, there is an advantage in the field curvature correction.

$$1.555 < N 1 nave < 1.9 \qquad ( 8 )$$

In order to obtain more favorable characteristics, the lower limit value of Conditional Expression (8) is more preferably 1.56, still more preferably 1.565, and still more preferably 1.57. In order to obtain more favorable characteristics, the upper limit value of Conditional Expression (8) is more preferably 1.88, still more preferably 1.86, and still more preferably 1.84.

In a case in which a back focus of the entire system at the air conversion distance in a state in which the infinite distance object is in focus is denoted by Bf, it is preferable that the imaging lens satisfies Conditional Expression (9). By not allowing the corresponding value of Conditional Expression (9) to be equal to or less than the lower limit value, there is an advantage in suppressing an increase in diameter of the lens located on the image side in the lens system. By not allowing the corresponding value of Conditional Expression (9) to be equal to or greater than the upper limit value, there is an advantage in reduction of the total length of the lens system.

$$0.4 < Bf / ( f \times tan ω m ) < 2.5 \qquad ( 9 )$$

In order to obtain more favorable characteristics, the lower limit value of Conditional Expression (9) is more preferably 0.45, still more preferably 0.48, still more preferably 0.5, still more preferably 0.52, and still more preferably 0.54. In order to obtain more favorable characteristics, the upper limit value of Conditional Expression (9) is more preferably 2, still more preferably 1.8, still more preferably 1.5, still more preferably 1.2, and still more preferably 1.1.

In a case in which a thickness of the second lens group G2 on the optical axis is denoted by DG2, it is preferable that the imaging lens satisfies Conditional Expression (10). It should be noted that the thickness of a certain group on the optical axis refers to a distance, on the optical axis, from a surface of the group closest to the object side to a surface of the group closest to the image side. As an example, FIG. 3 shows the thickness DG2. By not allowing the corresponding value of Conditional Expression (10) to be equal to or less than the lower limit value, it is possible to suppress fluctuation in spherical aberration and fluctuation in field curvature during focusing. By not allowing the corresponding value of Conditional Expression (10) to be equal to or greater than the upper limit value, there is an advantage in achieving reduction in total length and weight.

$$0.01 < DG 2 / TL < 0.4 \qquad ( 10 )$$

In order to obtain more favorable characteristics, the lower limit value of Conditional Expression (10) is more preferably 0.012, still more preferably 0.014, and still more preferably 0.015. In order to obtain more favorable characteristics, the upper limit value of Conditional Expression (10) is more preferably 0.36, still more preferably 0.34, and still more preferably 0.32.

In a case in which a maximum value of refractive indexes of all lenses included in the imaging lens at the d line is denoted by Nmax, it is preferable that the imaging lens satisfies Conditional Expression (11). By not allowing the corresponding value of Conditional Expression (11) to be equal to or less than the lower limit value, there is an advantage in suppressing the field curvature. By not allowing the corresponding value of Conditional Expression (11) to be equal to or greater than the upper limit value, there is an advantage in suppressing the error sensitivity of the surface shape.

$$1.8 < Nmax < 2.2 \qquad ( 11 )$$

In order to obtain more favorable characteristics, the lower limit value of Conditional Expression (11) is more preferably 1.82, still more preferably 1.84, and still more preferably 1.85. In order to obtain more favorable characteristics, the upper limit value of Conditional Expression (11) is more preferably 2.1, still more preferably 2.08, and still more preferably 2.06.

In a case in which an average value of refractive indexes of all positive lenses included in the imaging lens at a d line is denoted by Npave, it is preferable that the imaging lens satisfies Conditional Expression (12). By not allowing the corresponding value of Conditional Expression (12) to be equal to or less than the lower limit value, it is easy to reduce the absolute value of the Petzval sum of the entire lens system, so that there is an advantage in correcting the field curvature. By not allowing the corresponding value of Conditional Expression (12) to be equal to or greater than the upper limit value, it is easy to reduce the variance, so that there is an advantage in correcting the longitudinal chromatic aberration.

$$1.64 < Npave < 1.88 \qquad ( 12 )$$

In order to obtain more favorable characteristics, the lower limit value of Conditional Expression (12) is more preferably 1.65, still more preferably 1.66, still more preferably 1.68, and still more preferably 1.7. In order to obtain more favorable characteristics, the upper limit value of Conditional Expression (12) is more preferably 1.85, still more preferably 1.83, still more preferably 1.81, and still more preferably 1.8.

In a case in which a focal length of the first negative lens of the first lens group G1 is denoted by fL1, it is preferable that the imaging lens satisfies Conditional Expression (13). By not allowing the corresponding value of Conditional Expression (13) to be equal to or less than the lower limit value, the refractive power of the first negative lens is not excessively increased, so that there is an advantage in correcting astigmatism. By not allowing the corresponding value of Conditional Expression (13) to be equal to or greater than the upper limit value, the refractive power of the first negative lens is not excessively decreased, so that there is an advantage in achieving reduction in lens diameter.

$$- 2 < f / fL 1 < - 0.45 \qquad ( 13 )$$

In order to obtain more favorable characteristics, the lower limit value of Conditional Expression (13) is more preferably −1.5, still more preferably −1.3, and still more preferably-1.25. In order to obtain more favorable characteristics, the upper limit value of Conditional Expression (13) is more preferably −0.48, still more preferably −0.5, and still more preferably-0.52.

In a case in which a distance, on the optical axis, from the image plane Sim to the paraxial exit pupil position in a state in which the infinite distance object is in focus is denoted by Exp, it is preferable that the imaging lens satisfies Conditional Expression (14). However, a sign of Exp is defined such that, with the image plane Sim as a reference, a distance in a direction from the image plane Sim to the object side is negative and a distance in a direction from the object side to the image side is positive. In addition, in a case in which an optical member having no refractive power is disposed between the image plane Sim and the paraxial exit pupil position, Exp is calculated using the air conversion distance for the optical member. As an example, FIG. 3 schematically shows the distance Exp. In FIG. 3, an optical member that has a parallel plate shape, that has no refractive power, and that is calculated using the air conversion distance is indicated by a broken line. By not allowing the corresponding value of Conditional Expression (14) to be equal to or less than the lower limit value, there is an advantage in achieving reduction in total length of the lens system. By not allowing the corresponding value of Conditional Expression (14) to be equal to or greater than the upper limit value, there is an advantage in ensuring the peripheral light amount.

$$- 5 < Exp / ( f \times tan ω m ) < - 1.4 \qquad ( 14 )$$

In order to obtain more favorable characteristics, the lower limit value of Conditional Expression (14) is more preferably −4.5, still more preferably −4.4, still more preferably −4.2, and still more preferably −4.1. In order to obtain more favorable characteristics, the upper limit value of Conditional Expression (14) is more preferably −1.5, still more preferably −1.6, still more preferably −1.7, and still more preferably −1.8.

In a configuration in which the second lens group G2 has a positive refractive power, and the third lens group G3 has a negative refractive power, it is preferable that the imaging lens satisfies Conditional Expression (15). Here, a focal length of the first lens group G1 is denoted by f1. By not allowing the corresponding value of Conditional Expression (15) to be equal to or less than the lower limit value, there is an advantage in achieving reduction in total length of the lens system. By not allowing the corresponding value of Conditional Expression (15) to be equal to or greater than the upper limit value, there is an advantage in achieving a wide angle of view.

$$- 1.5 < f / f 1 < 1.5 \qquad ( 15 )$$

In order to obtain more favorable characteristics, the lower limit value of Conditional Expression (15) is more preferably −1.2, still more preferably −0.8, still more preferably −0.7, still more preferably −0.65, and still more preferably −0.63. In order to obtain more favorable characteristics, the upper limit value of Conditional Expression (15) is more preferably 1.2, still more preferably 1, still more preferably 0.8, still more preferably 0.7, and still more preferably 0.67.

In a configuration in which the second lens group G2 has a positive refractive power, and the third lens group G3 has a negative refractive power, it is preferable that the imaging lens satisfies Conditional Expression (16). Here, a focal length of the second lens group G2 is denoted by f2. A focal length of the third lens group G3 is denoted by f3. By not allowing the corresponding value of Conditional Expression (16) to be equal to or less than the lower limit value, it is easy to prevent excessive correction of field curvature. By not allowing the corresponding value of Conditional Expression (16) to be equal to or greater than the upper limit value, it is easy to prevent insufficient correction of field curvature.

$$- 1.1 < f 2 / f 3 < - 0.07 \qquad ( 16 )$$

In order to obtain more favorable characteristics, the lower limit value of Conditional Expression (16) is more preferably −1, still more preferably −0.95, still more preferably −0.9, still more preferably −0.85, and still more preferably −0.8. In order to obtain more favorable characteristics, the upper limit value of Conditional Expression (16) is more preferably −0.08, still more preferably −0.09, still more preferably −0.1, still more preferably −0.11, and still more preferably −0.12.

In a configuration in which the second lens group G2 has a positive refractive power, and the third lens group G3 has a negative refractive power, it is preferable that the imaging lens satisfies Conditional Expression (17). By not allowing the corresponding value of Conditional Expression (17) to be equal to or less than the lower limit value, there is an advantage in the field curvature correction. By not allowing the corresponding value of Conditional Expression (17) to be equal to or greater than the upper limit value, there is an advantage in reduction of the total length of the lens system.

$$- 1.1 < f / f 3 < - 0.03 \qquad ( 17 )$$

In order to obtain more favorable characteristics, the lower limit value of Conditional Expression (17) is more preferably −1, still more preferably −0.9, still more preferably −0.8, still more preferably −0.7, and still more preferably −0.6. In order to obtain more favorable characteristics, the upper limit value of Conditional Expression (17) is more preferably −0.05, still more preferably −0.1, still more preferably −0.11, still more preferably −0.13, and still more preferably −0.15.

In a configuration in which the second lens group G2 has a negative refractive power, and the third lens group G3 has a positive refractive power, it is preferable that the imaging lens satisfies Conditional Expression (15A). Here, a focal length of the first lens group G1 is denoted by f1. By not allowing the corresponding value of Conditional Expression (15A) to be equal to or less than the lower limit value, the refractive power of the first lens group G1 is not excessively decreased, so that there is an advantage in achieving reduction in total length of the lens system. By not allowing the corresponding value of Conditional Expression (15A) to be equal to or greater than the upper limit value, the refractive power of the first lens group G1 is not excessively increased, so that there is an advantage in suppressing fluctuation in aberration during focusing.

$$1 < f / f 1 < 3 \qquad ( 15 A )$$

In order to obtain more favorable characteristics, the lower limit value of Conditional Expression (15A) is more preferably 1.3, still more preferably 1.5, and still more preferably 1.7. In order to obtain more favorable characteristics, the upper limit value of Conditional Expression (15A) is more preferably 2.5, still more preferably 2.2, and still more preferably 2.

In a configuration in which the second lens group G2 has a negative refractive power, and the third lens group G3 has a positive refractive power, it is preferable that the imaging lens satisfies Conditional Expression (17A). Here, a focal length of the third lens group G3 is denoted by f3. By not allowing the corresponding value of Conditional Expression (17A) to be equal to or less than the lower limit value, there is an advantage in achieving reduction in total length of the lens system. By not allowing the corresponding value of Conditional Expression (17A) to be equal to or greater than the upper limit value, there is an advantage in the field curvature correction.

$$0.1 < f / f 3 < 0.7 \qquad ( 17 A )$$

In order to obtain more favorable characteristics, the lower limit value of Conditional Expression (17A) is more preferably 0.13, still more preferably 0.135, still more preferably 0.14, still more preferably 0.145, and still more preferably 0.15. In order to obtain more favorable characteristics, the upper limit value of Conditional Expression (17A) is more preferably 0.6, still more preferably 0.55, still more preferably 0.5, still more preferably 0.45, and still more preferably 0.42.

In a case in which a thickness of the first lens group G1 on the optical axis is denoted by DG1, it is preferable that the imaging lens satisfies Conditional Expression (18). As an example, FIG. 3 shows the thickness DG1. By not allowing the corresponding value of Conditional Expression (18) to be equal to or less than the lower limit value, there is an advantage in correcting lateral chromatic aberration and distortion. By not allowing the corresponding value of Conditional Expression (18) to be equal to or greater than the upper limit value, there is an advantage in achieving reduction in total length and weight.

$$0.1 < DG 1 / TL < 0.55 \qquad ( 18 )$$

In order to obtain more favorable characteristics, the lower limit value of Conditional Expression (18) is more preferably 0.11, still more preferably 0.115, still more preferably 0.12, still more preferably 0.125, and still more preferably 0.13. In order to obtain more favorable characteristics, the upper limit value of Conditional Expression (18) is more preferably 0.5, still more preferably 0.4, still more preferably 0.3, still more preferably 0.2, and still more preferably 0.17.

In a case in which a thickness of the third lens group G3 on the optical axis is denoted by DG3, it is preferable that the imaging lens satisfies Conditional Expression (19). As an example, FIG. 3 shows the thickness DG3. By not allowing the corresponding value of Conditional Expression (19) to be equal to or less than the lower limit value, there is an advantage in the field curvature correction. By not allowing the corresponding value of Conditional Expression (19) to be equal to or greater than the upper limit value, there is an advantage in achieving reduction in total length and weight.

$$0.01 < DG 3 / TL < 0.25 \qquad ( 19 )$$

In order to obtain more favorable characteristics, the lower limit value of Conditional Expression (19) is more preferably 0.013, still more preferably 0.015, and still more preferably 0.02. In order to obtain more favorable characteristics, the upper limit value of Conditional Expression (19) is more preferably 0.2, still more preferably 0.15, and still more preferably 0.12.

In a case in which a combined focal length of the first lens group G1 and the second lens group G2 in a state in which the infinite distance object is in focus is denoted by f12, it is preferable that the imaging lens satisfies Conditional Expression (20). By not allowing the corresponding value of Conditional Expression (20) to be equal to or less than the lower limit value, the combined refractive power of the first lens group G1 and the second lens group G2 is not excessively decreased, so that there is an advantage in achieving reduction in total length. By not allowing the corresponding value of Conditional Expression (20) to be equal to or greater than the upper limit value, the combined refractive power of the first lens group G1 and the second lens group G2 is not excessively increased, so that there is an advantage in suppressing spherical aberration.

$$0.5 < f / f 12 < 2.5 \qquad ( 20 )$$

In order to obtain more favorable characteristics, the lower limit value of Conditional Expression (20) is more preferably 0.6, still more preferably 0.65, still more preferably 0.68, and still more preferably 0.7. In order to obtain more favorable characteristics, the upper limit value of Conditional Expression (20) is more preferably 2, still more preferably 1.8, still more preferably 1.5, and still more preferably 1.4.

It should be noted that the example shown in FIG. 1 is merely an example, and various modifications can be made without departing from the gist of the technology of the present disclosure. For example, the number of lenses included in each group may be different from the number shown in the example of FIG. 1. In addition, the configuration of the lenses included in each lens group may be different from the example of FIG. 1.

The above-described preferred configurations and available configurations including the configurations related to the conditional expressions can be combined in any manner and are preferably selectively adopted, as appropriate, in accordance with required specifications.

As an example, an imaging lens of a preferred aspect of the present disclosure consists of, in order from an object side to an image side, a first lens group G1, a second lens group G2, and a third lens group G3, in which during focusing, the first lens group G1 and the third lens group G3 are fixed with respect to an image plane Sim and the second lens group G2 moves along an optical axis Z, a stop that is fixed with respect to the image plane Sim during focusing is disposed on the object side with respect to the second lens group G2, the first lens group G1 includes a first negative lens of which an image side surface is a concave surface, at a position closest to the object side, and the imaging lens satisfies Conditional Expressions (1) and (2).

Next, examples of the imaging lens according to the present disclosure will be described with reference to the drawings. It should be noted that reference numerals provided to the lens groups and the lenses in the cross-sectional view of each example are independently used for each example in order to avoid complication of description and the drawings caused by an increasing number of digits of the reference numerals. Accordingly, even in a case in which a common reference numeral is provided in the drawings of different examples, the common reference numeral does not always indicate a common configuration.

### Example 1

Since a cross-sectional view of the configuration of the imaging lens according to Example 1 is shown in FIG. 1, and its showing method and configuration are the same as described above, the duplicate descriptions will be partially omitted. The imaging lens according to Example 1 consists of, in order from the object side to the image side, the first lens group G1 having a positive refractive power, the second lens group G2 having a positive refractive power, and the third lens group G3 having a negative refractive power. The focusing group consists of only the second lens group G2. During focusing from the infinite distance object to the short distance object, the focusing group moves to the object side along the optical axis Z.

For the imaging lens of Example 1, Table 1 shows basic lens data, Table 2 shows specifications, Table 3 shows a variable surface spacing, and Table 4 shows an aspherical coefficient.

The table of the basic lens data is described as below. The column of“Sn” indicates surface numbers in a case in which the number is increased by one at a time toward the image side from a surface closest to the object side as a first surface. The column of“R” indicates a curvature radius of each surface. The column of“D” indicates a surface spacing on the optical axis between each surface and its adjacent surface on the image side. The column of“Nd” indicates a refractive index of each constituent element at the d line. The column of“vd” indicates an Abbe number of each constituent element based on the d line.

In the table of the basic lens data, a sign of a curvature radius of a surface having a convex shape facing the object side is defined as positive, and a sign of a curvature radius of a surface having a convex shape facing the image side is defined as negative. The field of a surface number of the surface corresponding to the aperture stop St has the term of the surface number (St). The table of basic lens data also shows the optical member PP. A value in the lowermost field of the column of D in the table indicates a spacing between a surface closest to the image side in the table and the image plane Sim. A symbol DD [ ] is used for the variable surface spacing during focusing, and a surface number on the object side of the spacing is provided in [ ] in the column of the surface spacing.

Table 2 shows the focal length f, the back focus Bf at the air conversion distance, the open F-number FNo, and a maximum full angle of view 2om of the imaging lens, based on the d line. In the field of the maximum full angle of view, [°] indicates that the unit is degrees. Table 2 shows a value in a state in which the infinite distance object is in focus.

In Table 3, the column of“variable surface spacing” shows the symbols of the variable surface spacing used in Table 1. The column of“infinite distance” shows the variable surface spacing in a state in which the infinite distance object is in focus. The column of“short distance” shows the variable surface spacing in a state in which the short distance object is in focus. In the field of“short distance”, the object distance of the short distance object is shown in parentheses. The“object distance” is a distance, on the optical axis, from the object to the lens surface closest to the object side. For example, in Example 1, the object distance is 86.716 millimeters (mm).

In the basic lens data, the reference sign * is attached to the surface number of the aspherical surface, and the numerical value of the paraxial curvature radius is written into the field of the curvature radius of the aspherical surface. In Table 4, the row of Sn shows the surface number of the aspherical surface, and the rows of KA and Am show numerical values of the aspherical coefficients for each aspherical surface. It should be noted that m of Am is an integer equal to or greater than 3, and varies depending on the surface. For example, in the first surface according to Example 1, m=3, 4, 5, . . . , and 16. In Table 4,“E±n” (n: integer) of the numerical value of the aspherical coefficient means“x 10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + Σ Am \times {h}^{m}$$

Here,
Zd: aspherical surface depth (a length of a perpendicular line drawn from a point on the aspherical surface at height h to a plane perpendicular to the optical axis Z where the apex of the aspherical surface is in contact),
h: height (distance from optical axis Z to lens surface),
C: reciprocal of paraxial curvature radius, and
KA, Am: aspherical coefficients,
and Σ means the sum with respect to m in aspherical surface equation.

Although, in the data of each table, a degree unit is used for angles, and a millimeter unit is used for lengths, since the optical system can also be proportionally enlarged or proportionally reduced to be used, other appropriate units can also be used. In addition, the numerical values rounded to predetermined digits are described in each table shown below.

TABLE 1
Example 1

| Sn | R | D | Nd | νd |
|---|---|---|---|---|
| *1 | 191.9946 | 1.2001 | 1.68948 | 31.02 |
| *2 | 15.6249 | 2.4998 | | |
| *3 | −42.9096 | 0.6998 | 1.53501 | 55.60 |
| *4 | 20.7369 | 0.9358 | | |
| 5 | −166.3331 | 1.7454 | 2.05090 | 26.94 |
| 6 | −23.4898 | 2.1460 | | |
| 7(St) | ∞ | 3.0002 | | |
| *8 | 144.8115 | 3.3776 | 1.61881 | 63.85 |
| *9 | −16.8093 | DD[9] | | |
| 10 | 16.6666 | 4.8098 | 1.45860 | 90.19 |
| 11 | −16.6666 | 0.9999 | 1.76182 | 26.52 |
| 12 | −551.8021 | 2.1147 | | |
| 13 | 34.8646 | 1.8000 | 1.49700 | 81.54 |
| 14 | 130.0369 | 0.7498 | 1.51680 | 64.20 |
| 15 | 25.9854 | 2.6920 | | |
| *16 | −68.9318 | 2.2998 | 1.85135 | 40.10 |
| *17 | −16.6666 | DD[17] | | |
| *18 | −21.6979 | 1.2498 | 1.68948 | 31.02 |
| *19 | ∞ | 8.3049 | | |
| 20 | ∞ | 2.8500 | 1.51680 | 64.20 |
| 21 | ∞ | 1.2000 | | |

TABLE 2
Example 1

| | |
|---|---|
| f | 18.56 |
| Bf | 11.40 |
| FNo. | 2.07 |
| 2ωm[°] | 81.4 |

TABLE 3
Example 1

| Variable | | Short |
|---|---|---|
| surface | Infinite | distance |
| spacing | distance | (86.716 mm) |
| DD[9] | 2.6520 | 0.4800 |
| DD[17] | 2.2251 | 4.3971 |

TABLE 4
Example 1

| Sn | 1 | 2 | 3 | 4 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.4408431E−03 | 1.9659306E−03 | 1.0794294E−04 | −1.0649555E−04 |
| A5 | −7.2882690E−06 | −5.1514626E−06 | 1.3718645E−06 | 2.6746887E−06 |
| A6 | −4.3807961E−05 | −3.4815829E−05 | −1.6296496E−05 | −1.0429868E−05 |
| A7 | 9.6402371E−08 | 4.4726579E−09 | −9.7086326E−08 | −2.1722137E−07 |
| A8 | 6.4483226E−07 | −5.3056556E−07 | 8.8535513E−08 | 2.4784601E−07 |
| A9 | 2.3083965E−10 | 2.0919949E−09 | 3.5142884E−09 | 3.2517739E−09 |
| A10 | −1.4927617E−09 | 4.1913499E−08 | 2.1685420E−08 | 7.1318179E−09 |
| A11 | −2.4290209E−11 | 1.9506047E−10 | 2.0935396E−13 | 6.6602076E−11 |
| A12 | −5.2032233E−11 | −5.9510962E−10 | −9.7984691E−10 | −3.5882537E−10 |
| A13 | 1.4456284E−13 | 2.5229893E−12 | 6.3907000E−13 | −2.1617204E−12 |
| A14 | −1.5740209E−13 | −3.1038493E−12 | 1.9834079E−11 | 3.1305100E−12 |
| A15 | 7.1514515E−15 | −1.0788698E−13 | 8.7180612E−14 | 9.1939016E−16 |
| A16 | 7.8649629E−15 | 1.1705692E−13 | −2.1053028E−13 | 7.4204633E−15 |
| Sn | 8 | 9 | 16 | 17 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.0632575E−04 | −2.0368318E−05 | −1.8467196E−04 | −1.4893480E−05 |
| A5 | −6.6561058E−06 | 1.7908510E−06 | 2.9450885E−06 | −7.5957131E−06 |
| A6 | 8.2546614E−07 | −1.2762775E−06 | 7.9060245E−07 | 9.8155692E−07 |
| A7 | 4.5828742E−08 | 1.1350027E−07 | −1.2860282E−08 | 5.4333413E−08 |
| A8 | −6.7271978E−09 | 3.4526321E−08 | −5.2803769E−09 | 3.7198628E−08 |
| A9 | −1.3805836E−09 | −6.7341320E−10 | −5.8273829E−10 | −2.2468133E−09 |
| A10 | −2.8347474E−11 | −8.1265890E−10 | 9.2410962E−10 | −2.0437788E−10 |
| A11 | 1.8888522E−11 | −3.8920369E−11 | 9.6470658E−12 | −2.0688628E−11 |
| A12 | 3.0251454E−12 | 1.4730790E−11 | −4.2842279E−12 | 8.1700744E−12 |
| A13 | 1.5158692E−13 | 7.4894777E−13 | 2.0464480E−13 | 1.6152126E−12 |
| A14 | −1.7970763E−14 | −1.1964643E−13 | −9.7996558E−14 | −2.5972490E−13 |
| A15 | −2.7298584E−15 | 4.6484487E−15 | 1.6288579E−15 | 1.7971731E−14 |
| A16 | −2.6501811E−18 | −5.0388861E−16 | 1.6084783E−16 | −1.4042957E−15 |

| Sn | 18 | 19 |
|---|---|---|
| KA | 1.0000000E+00 | 1.0000000E+00 |
| A3 | 0.0000000E+00 | 0.0000000E+00 |
| A4 | −2.2913498E−05 | −2.0500552E−04 |
| A5 | −9.0870809E−05 | −7.6259826E−06 |
| A6 | 1.0830423E−05 | −1.1767179E−06 |
| A7 | 5.5588248E−07 | 1.5575908E−07 |
| A8 | −1.4601962E−07 | 7.5128999E−09 |
| A9 | −8.8073294E−09 | 9.6834584E−10 |
| A10 | 3.5335745E−10 | −4.3746848E−10 |
| A11 | 1.6063023E−10 | −1.5172186E−11 |
| A12 | 1.6539374E−11 | 6.9346988E−12 |
| A13 | −5.4926036E−13 | 5.3301005E−14 |
| A14 | −2.9128738E−13 | −5.3235367E−14 |
| A15 | −1.5526259E−14 | 1.6618844E−16 |
| A16 | 2.6528207E−15 | 1.4314461E−16 |

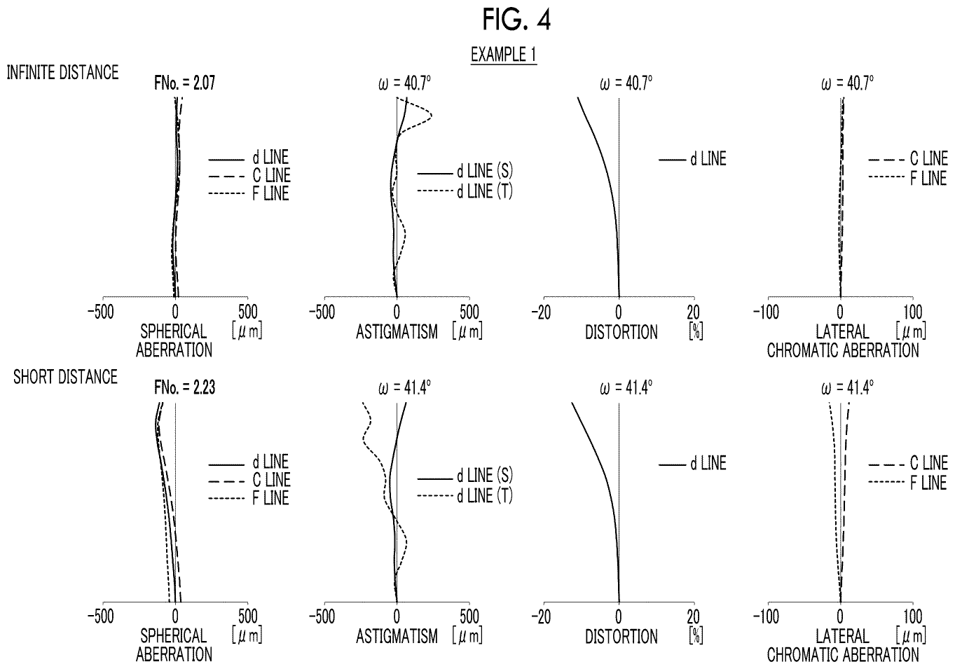

FIG. 4 shows each aberration diagram of the imaging lens according to Example 1. In FIG. 4, the spherical aberration, the astigmatism, the distortion, and the lateral chromatic aberration are shown in this order from the left side. In FIG. 4, the upper part labeled“infinite distance” shows each aberration diagram in a state in which the infinite distance object is in focus, and the lower part labeled“short distance” shows each aberration diagram in a state in which the short distance object at the object distance shown in the table of variable surface spacings is in focus. In the spherical aberration diagram, the aberrations at the d line, the C line, and the F line are shown by a solid line, a long broken line, and a short broken line, respectively. In the astigmatism diagram, the aberration at the d line in a sagittal direction is shown by a solid line, and the aberration at the d line in a tangential direction is shown by a short broken line. In the distortion diagram, the aberration at the d line is shown by a solid line. In the lateral chromatic aberration diagram, the aberrations on the C line and the F line are shown by a long broken line and a short broken line, respectively. In the spherical aberration diagram, a value of the open F-number is shown after “FNo.=”. In other aberration diagrams, a value of the maximum half angle of view is shown after“@=”. FNo. and @ in the upper part of the drawing correspond to FNo. and ωm of the above-described conditional expressions, respectively.

Symbols, meanings, description methods, and showing methods of each data related to Example 1 are basically the same for the following examples unless otherwise noted, and thus the duplicate descriptions will be omitted below.

### Example 2

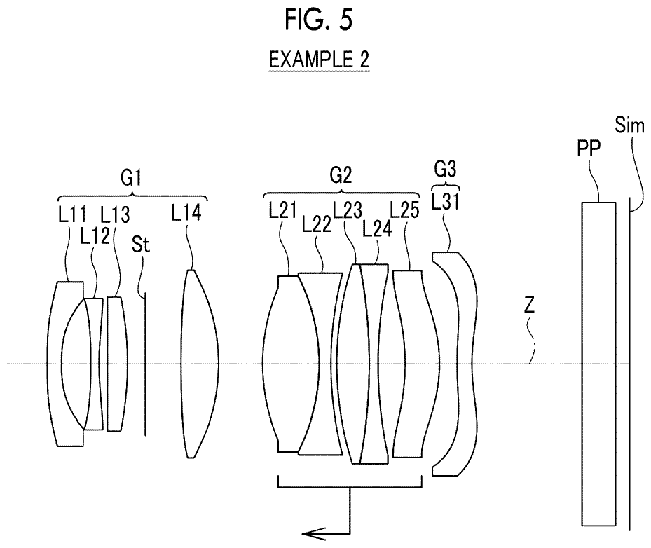

A cross-sectional view of a configuration of an imaging lens according to Example 2 is shown in FIG. 5. The imaging lens according to Example 2 consists of, in order from the object side to the image side, the first lens group G1 having a positive refractive power, the second lens group G2 having a positive refractive power, and the third lens group G3 having a negative refractive power. The first lens group G1 consists of, in order from the object side to the image side, lenses L11 to L13, an aperture stop St, and a lens L14. The second lens group G2 consists of, in order from the object side to the image side, five lenses, that is, lenses L21 to L25. The third lens group G3 consists of one lens, that is, the lens L31. The focusing group consists of only the second lens group G2. During focusing from the infinite distance object to the short distance object, the focusing group moves to the object side along the optical axis Z.

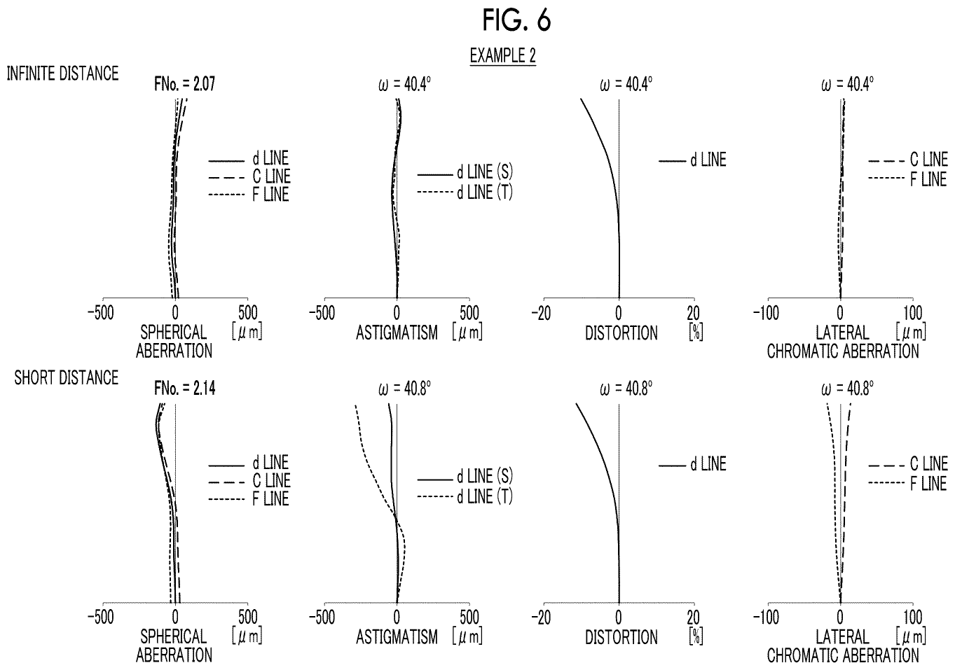

For the imaging lens of Example 2, Table 5 shows basic lens data, Table 6 shows specifications, Table 7 shows a variable surface spacing, Table 8 shows an aspherical coefficient, and FIG. 6 shows each aberration diagram.

TABLE 5
Example 2

| Sn | R | D | Nd | νd |
|---|---|---|---|---|
| *1 | 542.8848 | 1.2000 | 1.68948 | 31.02 |
| *2 | 15.6250 | 2.4998 | | |
| *3 | −61.1796 | 0.7000 | 1.51633 | 64.06 |
| *4 | 22.8206 | 0.7140 | | |
| 5 | −3689.0263 | 1.7066 | 2.05090 | 26.94 |
| 6 | −28.7295 | 1.4998 | | |
| 7(St) | ∞ | 3.0002 | | |
| *8 | 96.2271 | 3.1877 | 1.61881 | 63.85 |
| *9 | −17.0612 | DD[9] | | |
| 10 | 16.6666 | 4.8098 | 1.45860 | 90.19 |
| 11 | −16.6666 | 0.9998 | 1.69895 | 30.13 |
| 12 | 30.9648 | 0.4998 | | |
| 13 | 27.9868 | 2.7620 | 1.88300 | 40.80 |
| 14 | −44.8065 | 0.7498 | 1.62004 | 36.26 |
| 15 | 36.6796 | 2.2930 | | |
| *16 | −19.9088 | 2.9252 | 1.85400 | 40.38 |
| *17 | −13.1578 | DD[17] | | |
| *18 | 32.1847 | 1.2598 | 1.68948 | 31.02 |
| *19 | 16.6666 | 9.3106 | | |
| 20 | ∞ | 2.8500 | 1.51680 | 64.20 |
| 21 | ∞ | 1.2000 | | |

TABLE 6
Example 2

| | |
|---|---|
| f | 18.56 |
| Bf | 12.41 |
| FNo. | 2.07 |
| 2ωm[°] | 80.8 |

TABLE 7
Example 2

| Variable | | Short |
|---|---|---|
| surface | Infinite | distance |
| spacing | distance | (87.981 mm) |
| DD[9] | 3.7548 | 0.8374 |
| DD[17] | 1.5000 | 4.4174 |

TABLE 8
Example 2

| Sn | 1 | 2 | 3 | 4 |
|---|---|---|---|---|
| KA | 3.0343918E+02 | 9.3114687E−01 | 7.6377225E+00 | 5.4529049E−01 |
| A3 | 0.0000000E+00 | 0.0000000E+00 | 0.0000000E+00 | 0.0000000E+00 |
| A4 | 1.4013093E−03 | 1.8904175E−03 | −3.5753745E−04 | −6.0292649E−04 |
| A5 | 0.0000000E+00 | 0.0000000E+00 | 0.0000000E+00 | 0.0000000E+00 |
| A6 | −5.8027751E−05 | −5.2511967E−05 | 1.4280697E−06 | 1.2720694E−05 |
| A7 | 0.0000000E+00 | 0.0000000E+00 | 0.0000000E+00 | 0.0000000E+00 |
| A8 | 1.7095417E−06 | 4.6921596E−07 | −8.6338400E−08 | −5.0969140E−07 |
| A9 | 0.0000000E+00 | 0.0000000E+00 | 0.0000000E+00 | 0.0000000E+00 |
| A10 | −4.0704099E−08 | 4.8039714E−08 | 2.3214577E−08 | 3.8261587E−08 |
| A11 | 0.0000000E+00 | 0.0000000E+00 | 0.0000000E+00 | 0.0000000E+00 |
| A12 | 7.1082170E−10 | −3.0453995E−09 | −1.8141697E−09 | −2.0002937E−09 |
| A13 | 0.0000000E+00 | 0.0000000E+00 | 0.0000000E+00 | 0.0000000E+00 |
| A14 | −7.4273261E−12 | 8.0048553E−11 | 6.0044485E−11 | 5.5292544E−11 |
| A15 | 0.0000000E+00 | 0.0000000E+00 | 0.0000000E+00 | 0.0000000E+00 |
| A16 | 3.3468799E−14 | −7.7615711E−13 | −7.2359185E−13 | −6.1753348E−13 |
| Sn | 8 | 9 | 16 | 17 |
| KA | 3.3552050E+00 | 9.9931783E−01 | 1.0028939E+00 | 1.3311578E+00 |
| A3 | 0.0000000E+00 | 0.0000000E+00 | 0.0000000E+00 | 0.0000000E+00 |
| A4 | 4.0274434E−05 | −6.0184939E−05 | −1.2629343E−04 | 1.1013591E−04 |
| A5 | −7.8069630E−06 | 1.4004037E−06 | 2.9659712E−05 | −1.2432216E−05 |
| A6 | 1.3373931E−06 | 7.5427230E−07 | −2.7055026E−06 | 5.6415035E−06 |
| A7 | 1.6854302E−10 | −4.6871278E−07 | 5.6350879E−07 | −3.5548436E−07 |
| A8 | −1.2780679E−08 | 5.9870805E−08 | 3.1892690E−08 | 3.0648829E−08 |
| A9 | 1.1265276E−10 | 5.8195920E−09 | −3.4371901E−09 | 2.7636380E−09 |
| A10 | 2.4593248E−10 | −8.3064934E−10 | −4.1123955E−11 | 5.4702281E−11 |
| A11 | −1.4781408E−11 | −1.1633986E−10 | −4.7001383E−11 | −4.5088863E−11 |
| A12 | −2.7510638E−12 | 5.5065378E−12 | −4.2785282E−12 | −1.2075271E−12 |
| A13 | −4.0054955E−14 | 2.0019791E−12 | 5.0681178E−13 | 6.4721001E−13 |
| A14 | 6.4085874E−14 | −1.1994534E−13 | 1.3710426E−14 | −1.6931267E−13 |
| A15 | 1.6704428E−14 | 1.3491090E−14 | 6.0783767E−15 | 1.8137726E−14 |
| A16 | −2.2080634E−15 | −1.4856276E−15 | −5.4445281E−16 | −6.0759090E−16 |

| Sn | 18 | 19 |
|---|---|---|
| KA | 7.9214716E−01 | 9.1356299E−01 |
| A3 | 0.0000000E+00 | 0.0000000E+00 |
| A4 | −2.4440035E−04 | −3.2156063E−04 |
| A5 | −1.0308361E−04 | −1.0359048E−04 |
| A6 | 5.0269503E−06 | 9.6795163E−06 |
| A7 | 1.7511940E−06 | 6.1491462E−07 |
| A8 | −1.2068852E−07 | −3.0392181E−08 |
| A9 | −1.3811881E−08 | −5.8844009E−09 |
| A10 | 1.7652168E−10 | −5.2760405E−10 |
| A11 | 1.3001100E−10 | 2.4202467E−11 |
| A12 | 1.0367437E−11 | 9.3664328E−12 |
| A13 | −7.8131841E−13 | 1.7109721E−13 |
| A14 | −1.8374199E−13 | −6.9564953E−14 |
| A15 | 6.4344603E−18 | −4.0671336E−15 |
| A16 | 1.1095287E−15 | 4.4031266E−16 |

### Example 3

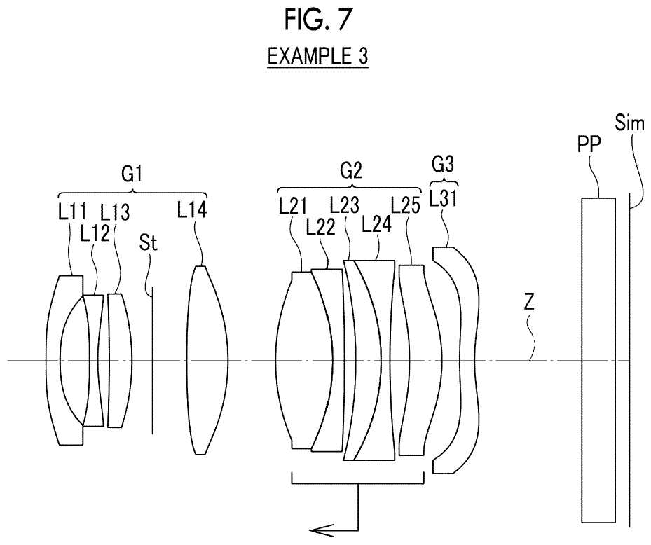

A cross-sectional view of a configuration of an imaging lens according to Example 3 is shown in FIG. 7. The imaging lens according to Example 3 consists of, in order from the object side to the image side, the first lens group G1 having a positive refractive power, the second lens group G2 having a positive refractive power, and the third lens group G3 having a negative refractive power. The first lens group G1 consists of, in order from the object side to the image side, lenses L11 to L13, an aperture stop St, and a lens L14. The second lens group G2 consists of, in order from the object side to the image side, five lenses, that is, lenses L21 to L25. The third lens group G3 consists of one lens, that is, the lens L31. The focusing group consists of only the second lens group G2. During focusing from the infinite distance object to the short distance object, the focusing group moves to the object side along the optical axis Z.

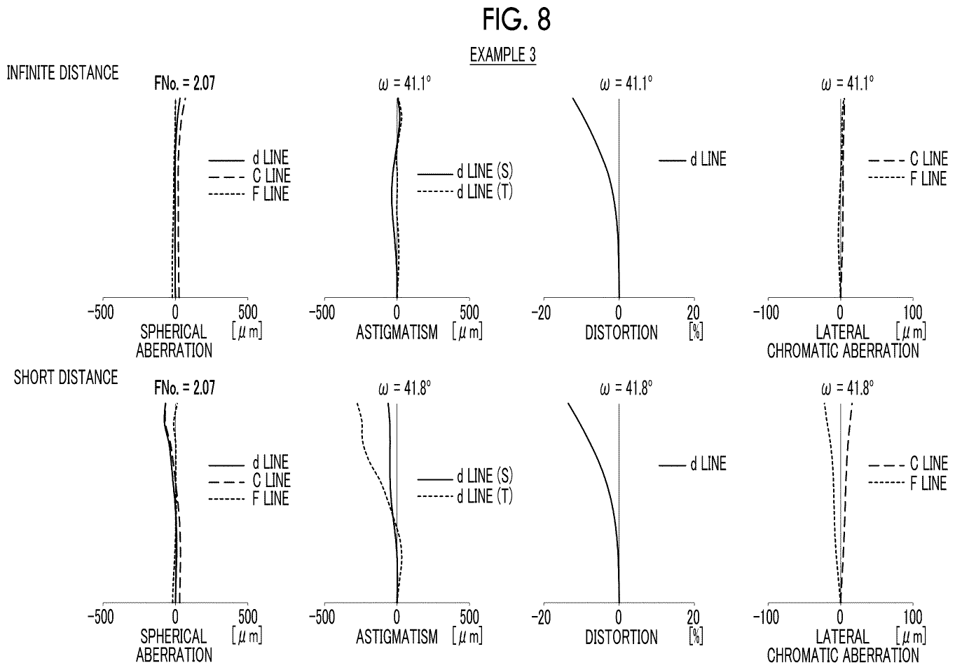

For the imaging lens of Example 3, Table 9 shows basic lens data, Table 10 shows specifications, Table 11 shows a variable surface spacing, Table 12 shows an aspherical coefficient, and FIG. 8 shows each aberration diagram.

TABLE 9
Example 3

| Sn | R | D | Nd | νd |
|---|---|---|---|---|
| *1 | 144.2677 | 1.2000 | 1.68948 | 31.02 |
| *2 | 16.7438 | 2.5000 | | |
| *3 | −76.6560 | 0.6999 | 1.58313 | 59.46 |
| *4 | 16.6666 | 0.9810 | | |
| 5 | −119.5577 | 1.9217 | 1.95375 | 32.32 |
| 6 | −18.7156 | 1.7574 | | |
| 7(St) | ∞ | 2.8994 | | |
| *8 | 86.6162 | 3.5032 | 1.61881 | 63.85 |
| *9 | −16.9782 | DD[9] | | |
| 10 | 17.4178 | 4.8098 | 1.49700 | 81.61 |
| 11 | −16.8096 | 0.9999 | 1.80809 | 22.76 |
| 12 | −148.0604 | 0.9581 | | |
| 13 | −35.1084 | 2.1570 | 1.83481 | 42.74 |
| 14 | −16.6666 | 0.7499 | 1.51742 | 52.43 |
| 15 | 76.2745 | 1.6671 | | |
| *16 | −22.2970 | 2.7501 | 1.85135 | 40.10 |
| *17 | −13.5134 | DD[17] | | |
| *18 | 30.2037 | 1.2698 | 1.68948 | 31.02 |
| *19 | 15.8228 | 9.1308 | | |
| 20 | ∞ | 2.8500 | 1.51680 | 64.20 |
| 21 | ∞ | 1.2000 | | |

TABLE 10
Example 3

| | |
|---|---|
| f | 18.56 |
| Bf | 12.21 |
| FNo. | 2.07 |
| 2ωm [°] | 82.2 |

TABLE 11
Example 3

| Variable | | Short |
|---|---|---|
| surface | Infinite | distance |
| spacing | distance | (86.821 mm) |
| DD[9] | 4.0500 | 0.8426 |
| DD[17] | 1.4999 | 4.7073 |

TABLE 12
Example 3

| Sn | 1 | 2 | 3 | 4 |
|---|---|---|---|---|
| KA | 1.1437881E+02 | 6.0826571E−01 | 1.2754781E+02 | 8.6297688E−01 |
| A3 | 0.0000000E+00 | 0.0000000E+00 | 0.0000000E+00 | 0.0000000E+00 |
| A4 | 1.3283166E−03 | 1.8368447E−03 | −6.7507301E−04 | −9.0812011E−04 |
| A5 | 0.0000000E+00 | 0.0000000E+00 | 0.0000000E+00 | 0.0000000E+00 |
| A6 | −4.9080194E−05 | −4.4852602E−05 | 2.3435449E−05 | 3.0525114E−05 |
| A7 | 0.0000000E+00 | 0.0000000E+00 | 0.0000000E+00 | 0.0000000E+00 |
| A8 | 1.4149965E−06 | 6.2537217E−07 | −8.1635121E−07 | −9.6401368E−07 |
| A9 | 0.0000000E+00 | 0.0000000E+00 | 0.0000000E+00 | 0.0000000E+00 |
| A10 | −3.3927860E−08 | 3.5512601E−08 | 3.4347273E−08 | 2.5584806E−08 |
| A11 | 0.0000000E+00 | 0.0000000E+00 | 0.0000000E+00 | 0.0000000E+00 |
| A12 | 5.6943844E−10 | −2.7155673E−09 | −1.5084925E−09 | −8.1469989E−10 |
| A13 | 0.0000000E+00 | 0.0000000E+00 | 0.0000000E+00 | 0.0000000E+00 |
| A14 | −5.4525859E−12 | 7.5746560E−11 | 4.1598670E−11 | 2.1711400E−11 |
| A15 | 0.0000000E+00 | 0.0000000E+00 | 0.0000000E+00 | 0.0000000E+00 |
| A16 | 2.1700482E−14 | −7.4561687E−13 | −4.7225461E−13 | −2.6743409E−13 |
| Sn | 8 | 9 | 16 | 17 |
| KA | 3.0000713E+00 | 8.5619858E−01 | 5.4895767E−01 | 8.3967790E−02 |
| A3 | 0.0000000E+00 | 0.0000000E+00 | 0.0000000E+00 | 0.0000000E+00 |
| A4 | 7.3750915E−05 | −3.5906483E−05 | −1.1566856E−04 | 1.5990360E−05 |
| A5 | −7.9765592E−06 | −6.2449589E−06 | 2.6147175E−05 | −8.1129327E−07 |
| A6 | 1.8077534E−06 | 2.7127976E−06 | −2.5816363E−06 | 2.5709629E−06 |
| A7 | −1.3532523E−07 | −4.8373814E−07 | 2.9926856E−07 | −1.5091640E−07 |
| A8 | −7.2266519E−09 | 2.6661873E−08 | 3.9155733E−08 | 1.6171161E−08 |
| A9 | 1.4301525E−09 | 4.7970047E−09 | 1.0623205E−09 | 1.8559252E−09 |
| A10 | 2.5171461E−10 | −2.6047418E−10 | 1.2201014E−11 | 1.0906349E−10 |
| A11 | −1.7695277E−11 | −5.5998455E−11 | −4.4132704E−11 | −9.2959262E−12 |
| A12 | −4.7387938E−12 | 4.1012874E−12 | −6.6080409E−12 | 6.9076003E−13 |
| A13 | −1.1552009E−13 | 1.8110093E−13 | −3.0678053E−13 | 3.6861363E−13 |
| A14 | 6.2542266E−14 | −1.0756674E−13 | 6.5092452E−14 | −1.1989766E−13 |
| A15 | 9.8864936E−15 | 1.6298163E−14 | 1.0874624E−14 | −1.1143840E−15 |
| A16 | −9.3113875E−16 | −3.6650070E−16 | −8.0167738E−16 | 7.2699200E−16 |

| Sn | 18 | 19 |
|---|---|---|
| KA | −1.7539976E+00 | −3.7896532E−01 |
| A3 | 0.0000000E+00 | 0.0000000E+00 |
| A4 | −6.5440826E−04 | −7.4510109E−04 |
| A5 | −1.3653424E−05 | −1.4681717E−06 |
| A6 | 2.4498894E−06 | 4.4124916E−06 |
| A7 | 6.9537203E−07 | 5.0019925E−08 |
| A8 | −7.6646078E−08 | −2.1062557E−08 |
| A9 | −9.1151932E−09 | −1.1598243E−09 |
| A10 | 4.1616385E−10 | −8.7260686E−11 |
| A11 | 1.0937537E−10 | 1.0411241E−11 |
| A12 | 6.9651161E−12 | 2.3593391E−12 |
| A13 | −5.5654980E−13 | −5.6744786E−14 |
| A14 | −1.9710495E−13 | −2.5117034E−14 |
| A15 | −8.8368888E−15 | −5.3438818E−16 |
| A16 | 1.9920229E−15 | 1.6228608E−16 |

### Example 4

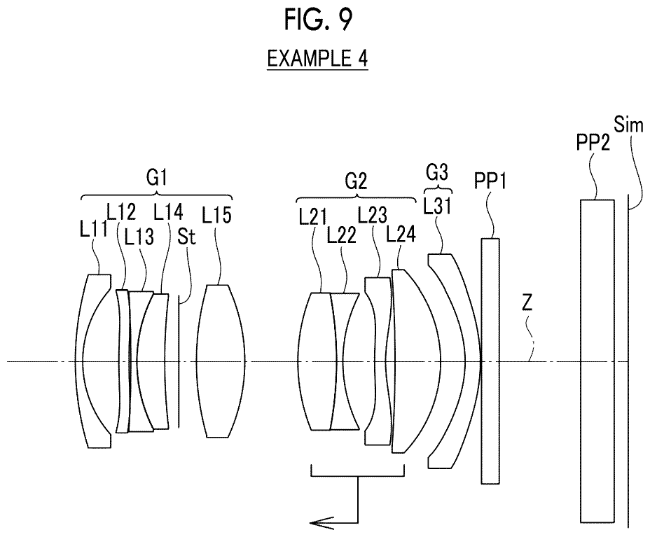

A cross-sectional view of a configuration of an imaging lens according to Example 4 is shown in FIG. 9. The imaging lens according to Example 4 consists of, in order from the object side to the image side, the first lens group G1 having a positive refractive power, the second lens group G2 having a positive refractive power, and the third lens group G3 having a negative refractive power. The first lens group G1 consists of, in order from the object side to the image side, lenses L11 to L14, an aperture stop St, and a lens L15. The second lens group G2 consists of, in order from the object side to the image side, four lenses, that is, lenses L21 to L24. The third lens group G3 consists of one lens, that is, the lens L31. The focusing group consists of only the second lens group G2. During focusing from the infinite distance object to the short distance object, the focusing group moves to the object side along the optical axis Z.

In Example 4, optical members PP1 and PP2 are disposed between the imaging lens and the image plane Sim. The optical members PP1 and PP2 are parallel flat plate-shaped members having no refractive power. The optical member PP2 has the same function as the optical member PP according to Example 1. In a case in which the lens of the imaging lens closest to the image side is a plastic lens, the optical member PP1 may be disposed as a protective filter as in Example 4.

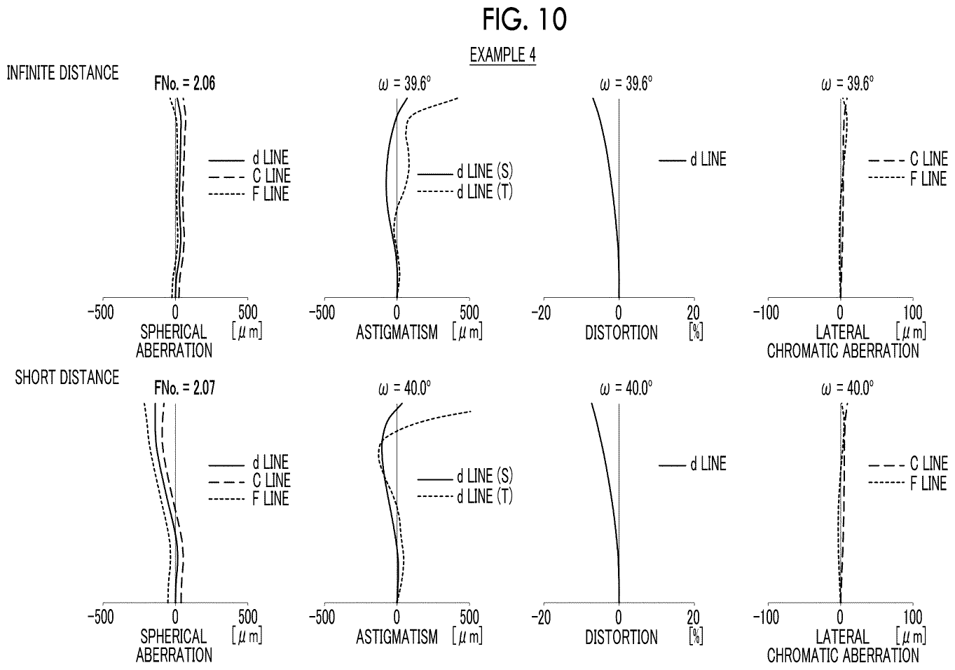

For the imaging lens of Example 4, Table 13 shows basic lens data, Table 14 shows specifications, Table 15 shows a variable surface spacing, Table 16 shows an aspherical coefficient, and FIG. 10 shows each aberration diagram.

TABLE 13
Example 4

| Sn | R | D | Nd | νd |
|---|---|---|---|---|
| 1 | 25.1557 | 0.6278 | 1.61720 | 53.91 |
| 2 | 9.3374 | 3.0757 | | |
| *3 | 41.8399 | 0.8658 | 1.63351 | 23.63 |
| *4 | 44.7089 | 0.1557 | | |
| 5 | −100.8237 | 0.5194 | 1.57501 | 41.50 |
| 6 | 12.5380 | 2.3610 | 1.90069 | 37.05 |
| 7 | 48.8649 | 1.1981 | | |
| 8(St) | ∞ | 1.4985 | | |
| 9 | 23.2520 | 4.1177 | 1.49700 | 81.55 |
| 10 | −15.3296 | DD[10] | | |
| 11 | 15.6193 | 3.2366 | 1.91082 | 35.24 |
| 12 | −31.4938 | 0.5469 | 1.78880 | 28.42 |
| 13 | 12.4962 | 2.7004 | | |
| *14 | 26.5072 | 0.9335 | 1.58364 | 30.27 |
| *15 | 12.0535 | 0.8044 | | |
| 16 | −106.8318 | 3.8755 | 1.75500 | 52.32 |
| 17 | −11.3402 | DD[17] | | |
| *18 | −9.7593 | 1.2972 | 1.63351 | 23.63 |
| *19 | −13.6188 | 0.0999 | | |
| 20 | ∞ | 1.5000 | 1.51680 | 64.20 |
| 21 | ∞ | 6.9509 | | |
| 22 | ∞ | 2.8500 | 1.51680 | 64.20 |
| 23 | ∞ | 1.2000 | | |

TABLE 14
Example 4

| | |
|---|---|
| f | 18.47 |
| Bf | 11.12 |
| FNo. | 2.06 |
| 2ωm [°] | 79.2 |

TABLE 15
Example 4

| Variable | | Short |
|---|---|---|
| surface | Infinite | distance |
| spacing | distance | (102 mm) |
| DD[10] | 4.5129 | 1.9925 |
| DD[17] | 2.0882 | 4.6086 |

TABLE 16
Example 4

| Sn | 3 | 4 | 14 | 15 |
|---|---|---|---|---|
| KA | 5.0000013E+00 | −5.0000084E+00 | −5.0000079E+00 | 1.5460432E+00 |
| A3 | 0.0000000E+00 | 0.0000000E+00 | 0.0000000E+00 | 0.0000000E+00 |
| A4 | −4.6732842E−04 | −4.0017793E−04 | −1.0782189E−03 | −9.5757532E−04 |
| A5 | 1.4622686E−05 | 1.1838383E−04 | −6.9512770E−05 | −1.0265409E−04 |
| A6 | −5.1187900E−06 | −1.0444689E−04 | −1.8199918E−05 | −1.1663807E−05 |
| A7 | −1.3339954E−05 | 2.2171389E−05 | 5.6951698E−06 | 1.0189152E−05 |
| A8 | 6.4035477E−06 | 3.7801160E−06 | 2.5694024E−06 | 7.8189941E−07 |
| A9 | −4.9590080E−07 | −1.9417324E−06 | −7.0948790E−07 | −5.6069859E−07 |
| A10 | −2.7012162E−07 | 6.0915795E−08 | −5.0131696E−08 | 1.2777279E−08 |
| A11 | 5.6349987E−08 | 6.0071122E−08 | 2.6547007E−08 | 1.3362720E−08 |
| A12 | 1.8897598E−09 | −5.6661713E−09 | −4.5138125E−10 | −9.4394888E−10 |
| A13 | −1.3438330E−09 | −8.1364517E−10 | −4.0641393E−10 | −1.4350162E−10 |
| A14 | 6.2728095E−11 | 1.0791832E−10 | 1.9483698E−11 | 1.4162409E−11 |
| A15 | 1.0106991E−11 | 4.0558536E−12 | 2.2336626E−12 | 5.6884968E−13 |
| A16 | −8.1914930E−13 | −6.7505986E−13 | −1.3273689E−13 | −6.8163820E−14 |

| Sn | 18 | 19 |
|---|---|---|
| KA | 9.8499865E−01 | 1.1880857E+00 |
| A3 | 0.0000000E+00 | 0.0000000E+00 |
| A4 | 6.9067647E−04 | 5.6497515E−04 |
| A5 | −1.2902292E−04 | −1.0730961E−04 |
| A6 | −1.8610447E−06 | −7.2848858E−06 |
| A7 | 5.3235191E−06 | 4.9816994E−06 |
| A8 | −4.3872542E−07 | −9.2319866E−08 |
| A9 | −6.0287053E−08 | −1.0472198E−07 |
| A10 | 9.0836107E−09 | 4.9986565E−09 |
| A11 | −1.2264611E−10 | 1.2186185E−09 |
| A12 | −4.3892784E−11 | −7.6259115E−11 |
| A13 | 6.2834104E−12 | −7.5696969E−12 |
| A14 | −3.0757766E−13 | 5.2380432E−13 |
| A15 | −2.9941716E−14 | 1.9462934E−14 |
| A16 | 2.2698125E−15 | −1.3837099E−15 |

### Example 5

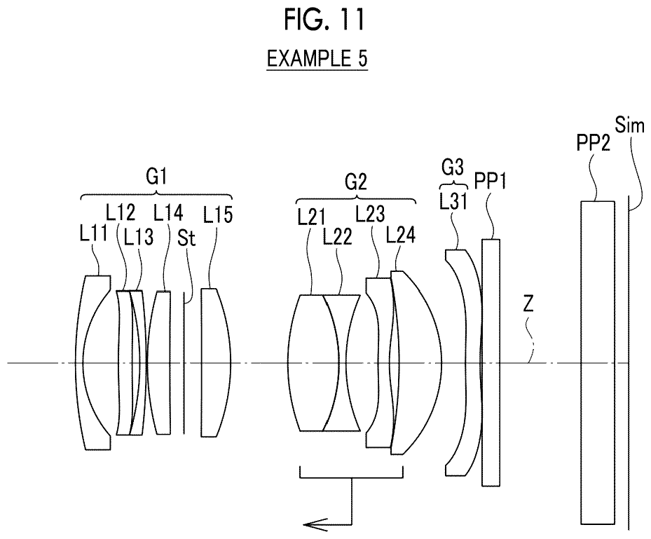

A cross-sectional view of a configuration of an imaging lens according to Example 5 is shown in FIG. 11. The imaging lens according to Example 5 consists of, in order from the object side to the image side, the first lens group G1 having a positive refractive power, the second lens group G2 having a positive refractive power, and the third lens group G3 having a negative refractive power. The first lens group G1 consists of, in order from the object side to the image side, lenses L11 to L14, an aperture stop St, and a lens L15. The second lens group G2 consists of, in order from the object side to the image side, four lenses, that is, lenses L21 to L24. The third lens group G3 consists of one lens, that is, the lens L31. The focusing group consists of only the second lens group G2. During focusing from the infinite distance object to the short distance object, the focusing group moves to the object side along the optical axis Z.

In Example 5, optical members PP1 and PP2 are disposed between the imaging lens and the image plane Sim. The optical members PP1 and PP2 according to Example 5 have the same functions as the optical members PP1 and PP2 according to Example 4, respectively.

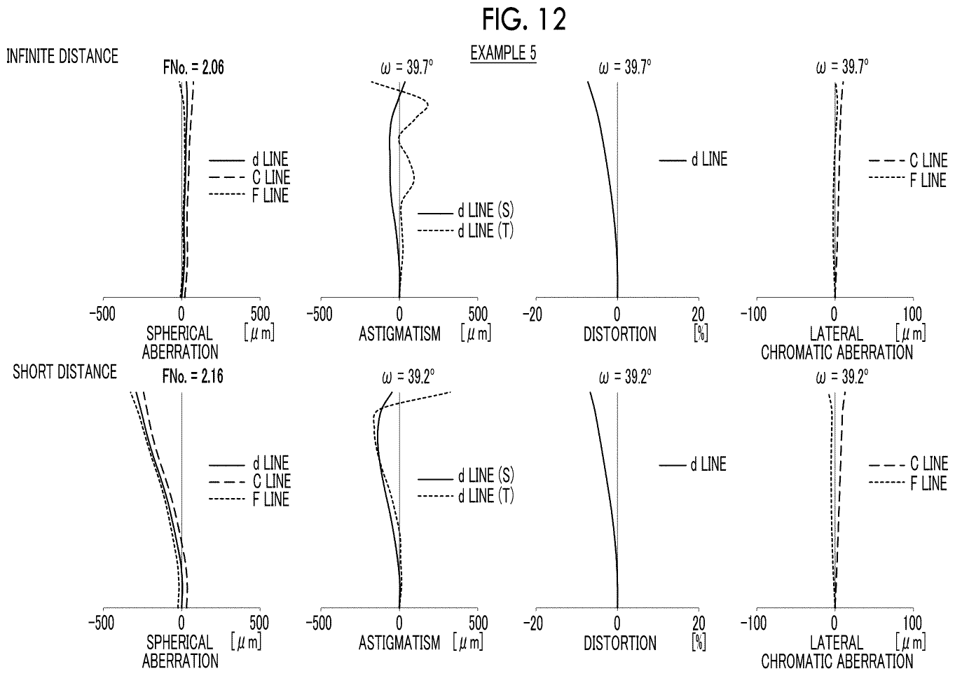

For the imaging lens of Example 5, Table 17 shows basic lens data, Table 18 shows specifications, Table 19 shows a variable surface spacing, Table 20 shows an aspherical coefficient, and FIG. 12 shows each aberration diagram.

TABLE 17
Example 5

| Sn | R | D | Nd | νd |
|---|---|---|---|---|
| 1 | 32.2084 | 0.6323 | 1.65411 | 39.68 |
| 2 | 9.4422 | 3.0175 | | |
| *3 | 48.7700 | 1.1694 | 1.63351 | 23.63 |
| *4 | 82.1164 | 0.6507 | | |
| 5 | −21.9196 | 0.5485 | 1.61340 | 44.27 |
| 6 | −53.4293 | 0.1000 | | |
| 7 | 23.0672 | 1.9071 | 1.85135 | 40.10 |
| 8 | 418.4537 | 1.1986 | | |
| 9(St) | ∞ | 1.4959 | | |
| 10 | −913.6761 | 2.4767 | 1.57144 | 71.61 |
| 11 | −16.7927 | DD[11] | | |
| 12 | 16.4698 | 4.2950 | 1.83441 | 37.27 |
| 13 | −13.2936 | 0.5988 | 1.74000 | 28.24 |
| 14 | 14.3441 | 2.7334 | | |
| *15 | 31.4275 | 0.9586 | 1.58364 | 30.27 |
| *16 | 13.4626 | 0.8289 | | |
| 17 | −38.2575 | 3.6133 | 1.72915 | 54.64 |
| 18 | −10.8351 | DD[18] | | |
| *19 | 45.5357 | 1.2393 | 1.63351 | 23.63 |
| *20 | 24.4675 | 0.1754 | | |
| 21 | ∞ | 1.5000 | 1.51680 | 64.20 |
| 22 | ∞ | 6.9336 | | |
| 23 | ∞ | 2.8500 | 1.51680 | 64.20 |
| 24 | ∞ | 1.2000 | | |

TABLE 18
Example 5

| | |
|---|---|
| f | 18.48 |
| Bf | 11.18 |
| FNo. | 2.06 |
| 2ωm [°] | 79.4 |

TABLE 19
Example 5

| Variable | | Short |
|---|---|---|
| surface | Infinite | distance |
| spacing | distance | (105 mm) |
| DD[11] | 4.8607 | 1.9950 |
| DD[18] | 2.0300 | 4.8957 |

TABLE 20
Example 5

| Sn | 3 | 4 | 15 | 16 |
|---|---|---|---|---|
| KA | −5.0000090E+00 | −5.0000065E+00 | −5.0000070E+00 | 1.9003321E+00 |
| A3 | 0.0000000E+00 | 0.0000000E+00 | 0.0000000E+00 | 0.0000000E+00 |
| A4 | −2.2895681E−04 | −1.1560835E−04 | −1.1328209E−03 | −1.0516410E−03 |
| A5 | 6.4856848E−05 | −1.9746465E−05 | −1.4326800E−04 | −2.0960211E−04 |
| A6 | −6.6227400E−05 | −4.3353079E−05 | −9.8090316E−06 | 6.9524175E−05 |
| A7 | 1.0848133E−05 | 1.7533338E−05 | 2.4598431E−05 | −2.0962770E−06 |
| A8 | 4.7186857E−06 | −4.0114561E−08 | −3.0472061E−06 | −1.9609381E−06 |
| A9 | −1.7154224E−06 | −1.1296920E−06 | −1.1480855E−06 | 3.1647800E−07 |
| A10 | −1.9651132E−08 | 1.3182605E−07 | 2.4830516E−07 | 1.6897717E−08 |
| A11 | 6.7569597E−08 | 2.6812275E−08 | 2.0293166E−08 | −7.9602565E−09 |
| A12 | −4.6831826E−09 | −4.9264585E−09 | −6.9670529E−09 | 2.2971000E−10 |
| A13 | −1.0754113E−09 | −2.5361662E−10 | −1.0745363E−10 | 8.2571989E−11 |
| A14 | 1.1532168E−10 | 7.0109407E−11 | 8.5024043E−11 | −5.0483275E−12 |
| A15 | 6.1042259E−12 | 6.5505570E−13 | −3.2132944E−13 | −3.1450555E−13 |
| A16 | −8.1203981E−13 | −3.5888005E−13 | −3.8199463E−13 | 2.4704916E−14 |

| Sn | 19 | 20 |
|---|---|---|
| KA | −5.0000011E+00 | −3.1987527E+00 |
| A3 | 0.0000000E+00 | 0.0000000E+00 |
| A4 | −5.7587986E−04 | −4.8085677E−04 |
| A5 | −4.8103983E−05 | −1.3873335E−04 |
| A6 | −5.9318043E−06 | 2.4851291E−05 |
| A7 | 6.6995234E−06 | 3.2835377E−06 |
| A8 | −1.6906404E−07 | −7.0968710E−07 |
| A9 | −2.3010546E−07 | −4.6139606E−08 |
| A10 | 1.8475814E−08 | 1.2081968E−08 |
| A11 | 3.2473648E−09 | 3.7476502E−10 |
| A12 | −3.6341699E−10 | −1.1819554E−10 |
| A13 | −2.0824057E−11 | −1.6513183E−12 |
| A14 | 2.9134058E−12 | 6.1339267E−13 |
| A15 | 4.9170688E−14 | 2.9092759E−15 |
| A16 | −8.7669888E−15 | −1.3195476E−15 |

### Example 6

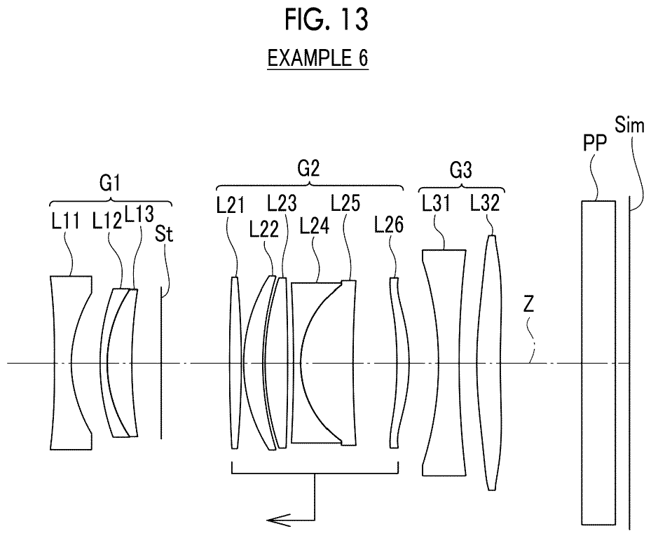

A cross-sectional view of a configuration of an imaging lens according to Example 6 is shown in FIG. 13. The imaging lens according to Example 6 consists of, in order from the object side to the image side, a first lens group G1 having a negative refractive power, a second lens group G2 having a positive refractive power, and a third lens group G3 having a negative refractive power. The first lens group G1 consists of, in order from the object side to the image side, lenses L11 to L13 and an aperture stop St. The second lens group G2 consists of, in order from the object side to the image side, six lenses, that is, lenses L21 to L26. The third lens group G3 consists of, in order from the object side to the image side, two lenses, that is, lenses L31 and L32. The focusing group consists of only the second lens group G2. During focusing from the infinite distance object to the short distance object, the focusing group moves to the object side along the optical axis Z.

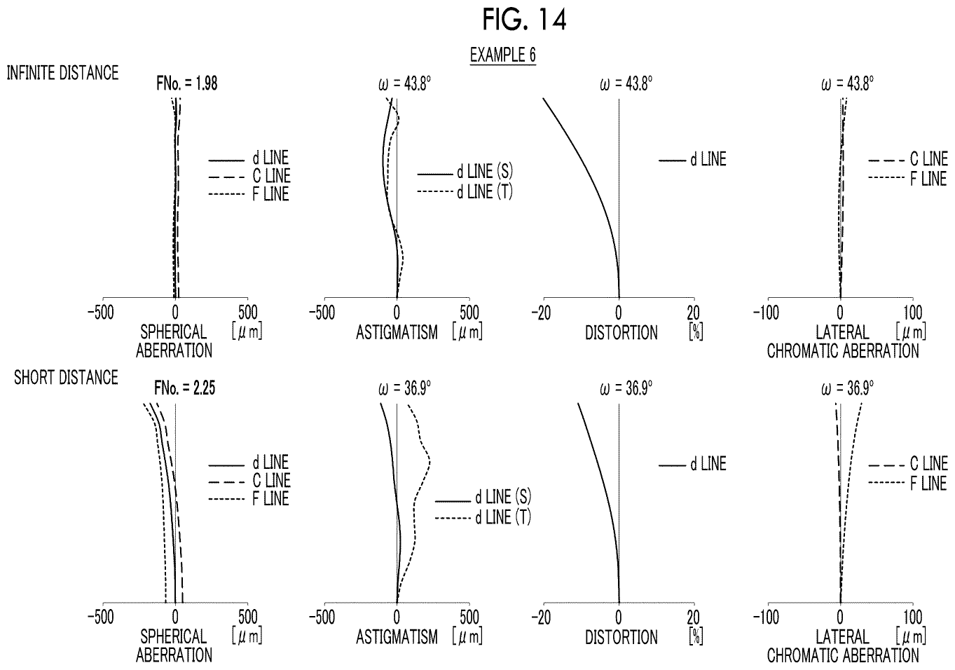

For the imaging lens of Example 6, Table 21 shows basic lens data, Table 22 shows specifications, Table 23 shows a variable surface spacing, Table 24 shows an aspherical coefficient, and FIG. 14 shows each aberration diagram.

TABLE 21
Example 6

| Sn | R | D | Nd | νd |
|---|---|---|---|---|
| *1 | 0.0000 | 1.4327 | 1.64242 | 59.38 |
| *2 | 9.7925 | 2.4487 | | |
| 3 | 18.5486 | 0.6096 | 1.95441 | 17.28 |
| 4 | 11.2538 | 2.0857 | 1.96113 | 30.06 |
| 5 | 40.3036 | 2.4997 | | |
| 6(St) | ∞ | DD[6] | | |
| 7 | 135.6200 | 1.0000 | 1.61519 | 60.57 |
| 8 | −80.0125 | 0.1996 | | |
| 9 | 13.7315 | 1.6230 | 1.66706 | 58.15 |
| 10 | 24.6127 | 0.2000 | | |
| 11 | 22.8975 | 1.9123 | 2.00001 | 17.69 |
| 12 | −194.6379 | 0.4998 | | |
| 13 | −128.3972 | 0.5996 | 1.81729 | 24.14 |
| 14 | 8.1167 | 4.4105 | 1.68438 | 58.48 |
| 15 | 100.9017 | 3.7291 | | |
| *16 | −35.8797 | 1.0336 | 1.82428 | 46.57 |
| *17 | −16.2504 | DD[17] | | |
| 18 | −28.5062 | 1.7496 | 1.83749 | 23.13 |
| 19 | 80.6980 | 1.4996 | | |
| *20 | 35.9338 | 1.9996 | 1.79670 | 48.33 |
| *21 | 77.8069 | 6.9411 | | |
| 22 | ∞ | 2.8500 | 1.51680 | 64.20 |
| 23 | ∞ | 1.2000 | | |

TABLE 22
Example 6

| | |
|---|---|
| f | 18.56 |
| Bf | 10.02 |
| FNo. | 1.98 |
| 2ωm [°] | 87.6 |

TABLE 23
Example 6

| Variable | | Short |
|---|---|---|
| surface | Infinite | distance |
| spacing | distance | (101 mm) |
| DD[6] | 5.8070 | 3.0973 |
| DD[17] | 2.4995 | 5.2092 |

TABLE 24
Example 6

| Sn | 1 | 2 | 16 | 17 |
|---|---|---|---|---|
| KA | 1.0000000E+00 | 1.0000000E+00 | 1.0000000E+00 | 1.0000000E+00 |
| A4 | −3.8864821E−04 | −4.9446059E−04 | −1.4496561E−04 | 4.0480286E−05 |
| A6 | 1.3126920E−05 | 1.7053500E−05 | 1.2453660E−06 | −1.2454786E−07 |
| A8 | −3.0820833E−07 | −5.2083505E−07 | −2.6391228E−08 | 1.0302799E−07 |
| A10 | 4.7571638E−09 | 1.9465598E−09 | 2.5850179E−09 | −2.2515442E−09 |
| A12 | −6.8543295E−11 | 6.4289069E−10 | 6.1638116E−12 | 9.0125324E−11 |
| A14 | 1.9860680E−12 | −2.3232451E−11 | −4.1498005E−13 | −5.8848361E−13 |
| A16 | −5.0323932E−14 | 1.2175561E−13 | 3.3990845E−16 | −8.1561632E−15 |
| A18 | 6.3634407E−16 | 6.9342842E−15 | −1.5052932E−16 | −9.6550899E−17 |
| A20 | −3.0685252E−18 | −9.5532291E−17 | 1.9985381E−18 | 2.0345824E−18 |

| Sn | 20 | 21 |
|---|---|---|
| KA | 1.0000000E+00 | 1.0000000E+00 |
| A4 | −8.8906539E−05 | −1.3143506E−04 |
| A6 | 3.4622690E−07 | 4.0739687E−07 |
| A8 | 3.2357566E−09 | −5.2314104E−09 |
| A10 | −2.8964752E−10 | 9.8845937E−11 |
| A12 | 6.2864718E−12 | −8.5146091E−13 |
| A14 | −5.7915886E−14 | −7.8587781E−15 |
| A16 | 2.2297149E−16 | 3.0323784E−16 |
| A18 | −1.5948505E−19 | −2.8710962E−18 |
| A20 | −3.1519250E−22 | 9.2892495E−21 |

### Example 7

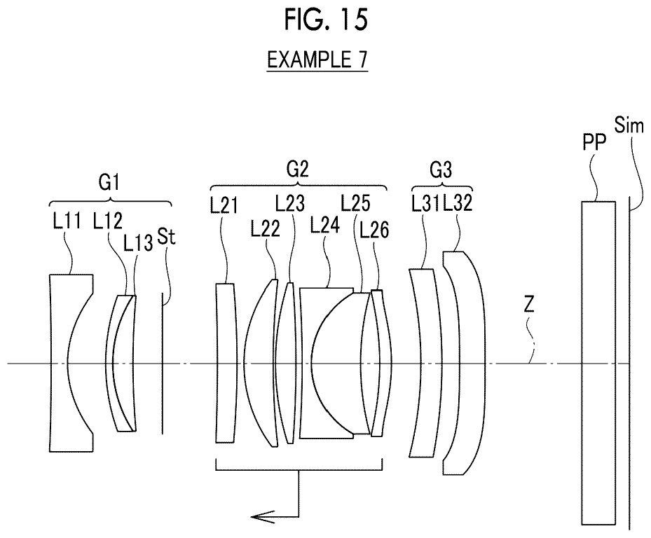

A cross-sectional view of a configuration of an imaging lens according to Example 7 is shown in FIG. 15. The imaging lens according to Example 7 consists of, in order from the object side to the image side, a first lens group G1 having a negative refractive power, a second lens group G2 having a positive refractive power, and a third lens group G3 having a negative refractive power. The first lens group G1 consists of, in order from the object side to the image side, lenses L11 to L13 and an aperture stop St. The second lens group G2 consists of, in order from the object side to the image side, six lenses, that is, lenses L21 to L26. The third lens group G3 consists of, in order from the object side to the image side, two lenses, that is, lenses L31 and L32. The focusing group consists of only the second lens group G2. During focusing from the infinite distance object to the short distance object, the focusing group moves to the object side along the optical axis Z.

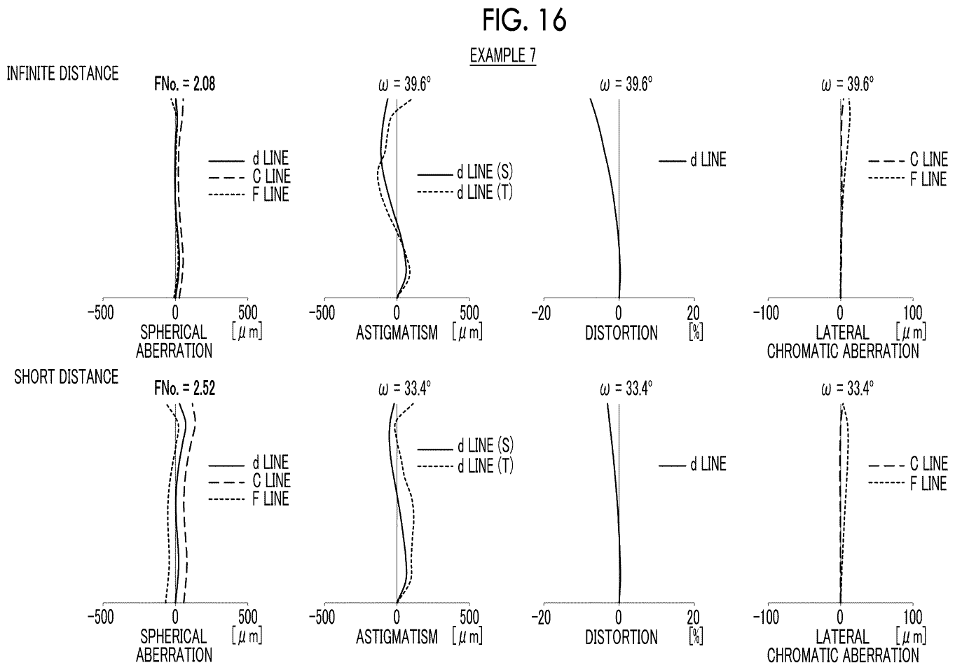

For the imaging lens of Example 7, Table 25 shows basic lens data, Table 26 shows specifications, Table 27 shows a variable surface spacing, Table 28 shows an aspherical coefficient, and FIG. 16 shows each aberration diagram.

TABLE 25
Example 7

| Sn | R | D | Nd | νd |
|---|---|---|---|---|
| *1 | 1516.4853 | 1.3996 | 1.57279 | 62.20 |
| *2 | 8.5279 | 3.2381 | | |
| 3 | 16.9683 | 0.6003 | 1.90796 | 19.60 |
| 4 | 10.5648 | 1.7216 | 1.83084 | 27.69 |
| 5 | 65.1261 | 2.5002 | | |
| 6(St) | ∞ | DD[6] | | |
| 7 | −175.1938 | 1.6670 | 1.57549 | 40.85 |
| 8 | −78.1129 | 0.5899 | | |
| 9 | 11.8018 | 2.4808 | 1.52027 | 64.22 |
| 10 | 63.7319 | 0.2000 | | |
| 11 | 22.8975 | 1.7364 | 1.72604 | 55.20 |
| 12 | −90.7128 | 0.5280 | | |
| 13 | −94.5619 | 0.7830 | 1.58476 | 39.61 |
| 14 | 6.9107 | 4.1308 | 1.52274 | 77.69 |
| 15 | 23.1735 | 1.6245 | | |
| *16 | −25.6044 | 1.0001 | 1.84130 | 44.83 |
| *17 | −15.9017 | DD[17] | | |
| 18 | −32.4843 | 1.7868 | 2.00000 | 15.00 |
| 19 | −42.9630 | 1.5005 | | |
| *20 | −158.4280 | 2.1648 | 1.85000 | 25.84 |
| *21 | −1175.7346 | 8.2375 | | |
| 22 | ∞ | 2.8500 | 1.51680 | 64.20 |
| 23 | ∞ | 1.2000 | | |

TABLE 26
Example 7

| | |
|---|---|
| f | 18.55 |
| Bf | 11.32 |
| FNo. | 2.08 |
| 2ωm[°] | 79.2 |

TABLE 27
Example 7

| Variable | | Short |
|---|---|---|
| surface | Infinite | distance |
| spacing | distance | (106 mm) |
| DD[6] | 4.6724 | 1.1111 |
| DD[17] | 2.5005 | 6.0618 |

TABLE 28
Example 7

| Sn | 1 | 2 | 16 | 17 |
|---|---|---|---|---|
| KA | 1.0000000E+00 | 1.0000000E+00 | 1.0000000E+00 | 1.0000000E+00 |
| A4 | −2.1006813E−04 | −3.6795063E−04 | −6.1142892E−05 | 1.4713676E−04 |
| A6 | 1.0038808E−05 | 1.5259716E−05 | 1.4834571E−06 | 1.0391150E−06 |
| A8 | −3.0100365E−07 | −6.2097545E−07 | 7.6717745E−09 | 1.2955207E−07 |
| A10 | 4.9792742E−09 | 4.4866497E−09 | 1.0361440E−09 | −1.9017952E−09 |
| A12 | −4.9121279E−11 | 5.7568437E−10 | 1.7126743E−11 | 6.5380452E−11 |
| A14 | 1.1781576E−12 | −2.2954718E−11 | −1.0870143E−12 | −7.5614304E−13 |
| A16 | −3.7977661E−14 | 2.9596627E−13 | 2.7039349E−15 | −2.1808325E−14 |
| A18 | 5.5044179E−16 | 7.6353339E−17 | −1.3975110E−16 | 2.7081480E−16 |
| A20 | −2.8464362E−18 | −2.0573128E−17 | 8.2967665E−19 | 2.8060097E−19 |

| Sn | 20 | 21 |
|---|---|---|
| KA | 3.3017206E+02 | −1.7274794E+07 |
| A4 | −1.8149484E−04 | −2.1589053E−04 |
| A6 | −4.6747889E−07 | 4.3440168E−07 |
| A8 | −1.1159736E−08 | −1.3811767E−08 |
| A10 | 8.6240443E−10 | 4.3802098E−10 |
| A12 | −1.3151585E−11 | −7.0344869E−12 |
| A14 | −1.7811393E−13 | 2.8377896E−14 |
| A16 | 6.4499051E−15 | 2.7475467E−16 |
| A18 | −5.8801236E−17 | −2.3265378E−18 |
| A20 | 1.5099434E−19 | 1.1190798E−22 |

### Example 8

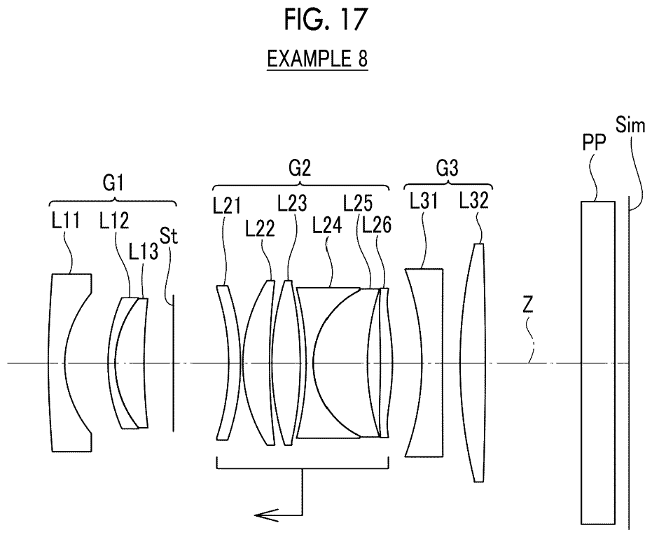

A cross-sectional view of a configuration of an imaging lens according to Example 8 is shown in FIG. 17. The imaging lens according to Example 8 consists of, in order from the object side to the image side, a first lens group G1 having a negative refractive power, a second lens group G2 having a positive refractive power, and a third lens group G3 having a negative refractive power. The first lens group G1 consists of, in order from the object side to the image side, lenses L11 to L13 and an aperture stop St. The second lens group G2 consists of, in order from the object side to the image side, six lenses, that is, lenses L21 to L26. The third lens group G3 consists of, in order from the object side to the image side, two lenses, that is, lenses L31 and L32. The focusing group consists of only the second lens group G2. During focusing from the infinite distance object to the short distance object, the focusing group moves to the object side along the optical axis Z.

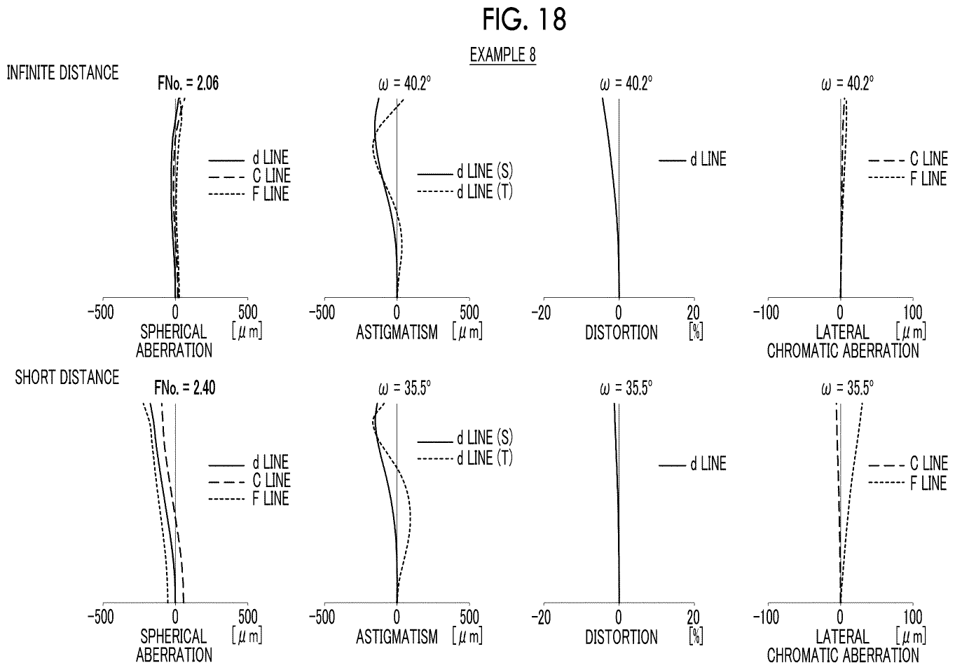

For the imaging lens of Example 8, Table 29 shows basic lens data, Table 30 shows specifications, Table 31 shows a variable surface spacing, Table 32 shows an aspherical coefficient, and FIG. 18 shows each aberration diagram.

TABLE 29
Example 8

| Sn | R | D | Nd | νd |
|---|---|---|---|---|
| *1 | 55.2922 | 1.4005 | 1.65262 | 58.87 |
| *2 | 8.2048 | 3.6816 | | |
| 3 | 13.9236 | 0.6005 | 1.99913 | 19.15 |
| 4 | 8.6327 | 2.4619 | 1.78880 | 28.43 |
| 5 | 47.4666 | 2.4999 | | |
| 6(St) | ∞ | DD[6] | | |
| 7 | −20.4157 | 0.9996 | 2.00001 | 15.00 |
| 8 | −20.2831 | 0.2003 | | |
| 9 | 12.9613 | 2.2684 | 1.55190 | 63.00 |
| 10 | 55.4103 | 0.2000 | | |
| 11 | 22.8975 | 2.4096 | 1.76226 | 51.77 |
| 12 | −31.3261 | 0.5003 | | |
| 13 | −25.6365 | 0.6100 | 1.55730 | 44.26 |
| 14 | 6.9033 | 4.5556 | 1.51482 | 78.89 |
| 15 | 19.8196 | 1.1050 | | |
| *16 | −80.3092 | 1.0260 | 1.85000 | 43.94 |
| *17 | −19.3023 | DD[17] | | |
| 18 | −22.9666 | 1.7496 | 1.90121 | 19.94 |
| 19 | 1020.7331 | 1.4996 | | |
| 20 | 41.6754 | 2.1422 | 1.79124 | 48.88 |
| 21 | −306.5212 | 8.1742 | | |
| 22 | ∞ | 2.8500 | 1.51680 | 64.20 |
| 23 | ∞ | 1.2000 | | |

TABLE 30
Example 8

| | |
|---|---|
| f | 17.57 |
| Bf | 11.25 |
| FNo. | 2.06 |
| 2ωm[°] | 80.4 |

TABLE 31
Example 8

| Variable | | Short |
|---|---|---|
| surface | Infinite | distance |
| spacing | distance | (95.069 mm) |
| DD[6] | 4.7040 | 2.0594 |
| DD[17] | 2.4998 | 5.1444 |

TABLE 32
Example 8

| Sn | 1 | 2 | 16 | 17 |
|---|---|---|---|---|
| KA | 1.0000000E+00 | 1.0000000E+00 | 1.0000000E+00 | 1.0000000E+00 |
| A4 | −2.0932613E−04 | −3.5973808E−04 | −2.6622218E−06 | 1.8728105E−04 |
| A6 | 9.3443741E−06 | 1.2673505E−05 | 3.4654816E−06 | 3.0483152E−06 |
| A8 | −2.8434303E−07 | −5.1083394E−07 | 1.5824668E−08 | 1.4495665E−07 |
| A10 | 4.8696127E−09 | 4.7273769E−10 | 2.7287427E−09 | −1.5557635E−09 |
| A12 | −5.0910969E−11 | 7.3862573E−10 | 7.9319147E−12 | 1.0529063E−10 |
| A14 | 1.2730525E−12 | −2.8842125E−11 | −3.1421572E−12 | −2.0898722E−12 |
| A16 | −4.0969800E−14 | 4.0298700E−13 | 4.6078997E−14 | −2.9422847E−14 |
| A18 | 5.9802506E−16 | −1.5991721E−16 | −4.4395412E−16 | 3.2799568E−16 |
| A20 | −3.1243344E−18 | −3.0995911E−17 | 1.6371540E−18 | 2.7786696E−18 |

### Example 9

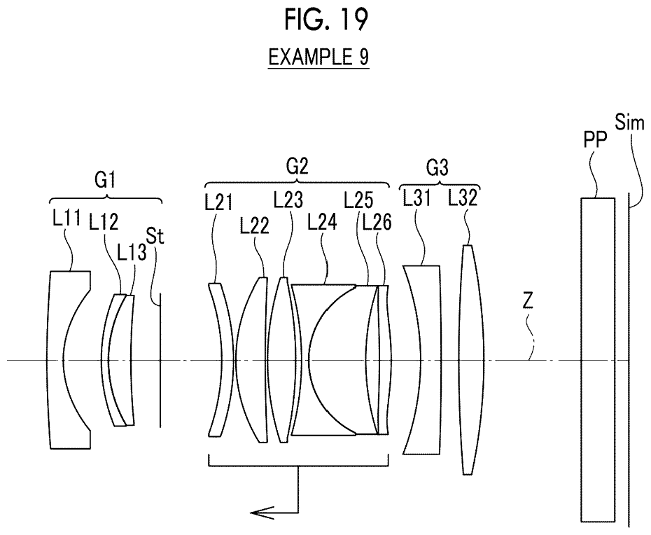

A cross-sectional view of a configuration of an imaging lens according to Example 9 is shown in FIG. 19. The imaging lens according to Example 9 consists of, in order from the object side to the image side, a first lens group G1 having a negative refractive power, a second lens group G2 having a positive refractive power, and a third lens group G3 having a negative refractive power. The first lens group G1 consists of, in order from the object side to the image side, lenses L11 to L13 and an aperture stop St. The second lens group G2 consists of, in order from the object side to the image side, six lenses, that is, lenses L21 to L26. The third lens group G3 consists of, in order from the object side to the image side, two lenses, that is, lenses L31 and L32. The focusing group consists of only the second lens group G2. During focusing from the infinite distance object to the short distance object, the focusing group moves to the object side along the optical axis Z.

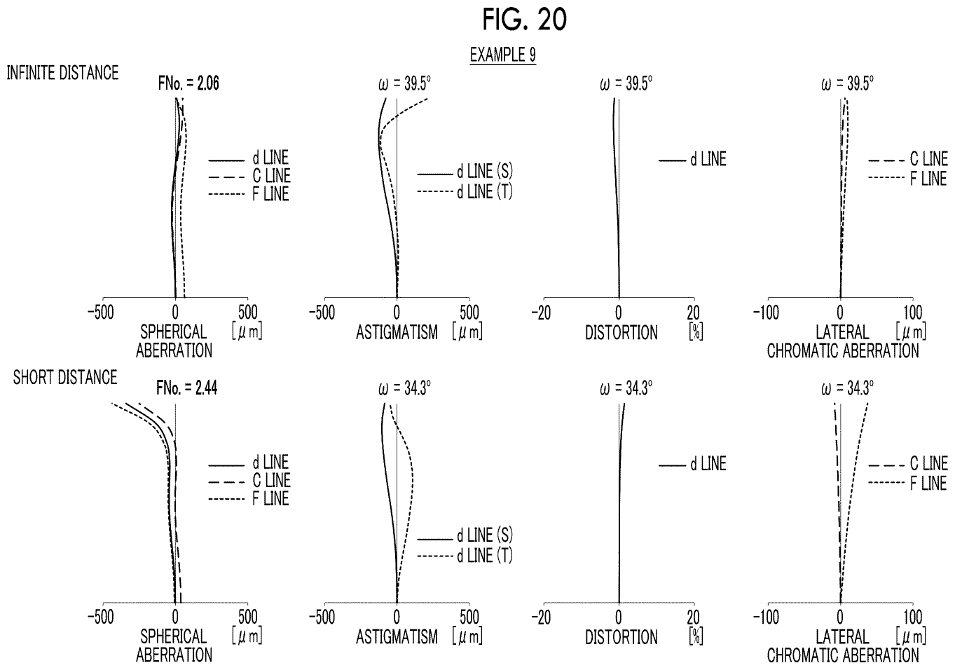

For the imaging lens of Example 9, Table 33 shows basic lens data, Table 34 shows specifications, Table 35 shows a variable surface spacing, Table 36 shows an aspherical coefficient, and FIG. 20 shows each aberration diagram.

TABLE 33
Example 9

| Sn | R | D | Nd | νd |
|---|---|---|---|---|
| *1 | 59.9781 | 1.4005 | 1.66337 | 58.33 |
| *2 | 8.1082 | 3.2400 | | |
| 3 | 14.7388 | 0.5995 | 2.00000 | 15.00 |
| 4 | 10.8369 | 1.9121 | 1.78880 | 28.43 |
| 5 | 54.7711 | 2.4998 | | |
| 6(St) | ∞ | DD[6] | | |
| 7 | −18.2652 | 1.0005 | 2.00000 | 28.00 |
| 8 | −19.5724 | 0.2001 | | |
| 9 | 13.2689 | 2.5000 | 1.55657 | 62.82 |
| 10 | 139.7384 | 0.2000 | | |
| 11 | 22.8975 | 2.3890 | 1.75197 | 52.80 |
| 12 | −31.3182 | 0.5003 | | |
| 13 | −23.9565 | 0.6103 | 1.54255 | 47.02 |
| 14 | 6.8333 | 4.8009 | 1.50855 | 79.85 |
| 15 | 20.3149 | 1.1656 | | |
| *16 | −74.6568 | 1.0002 | 1.84999 | 43.94 |
| *17 | −22.1632 | DD[17] | | |
| 18 | −22.1304 | 1.7497 | 1.93395 | 18.30 |
| 19 | −229.0042 | 1.4999 | | |
| 20 | 121.3023 | 2.1306 | 1.86348 | 41.65 |
| 21 | −45.9285 | 8.2795 | | |
| 22 | ∞ | 2.8500 | 1.51680 | 64.20 |
| 23 | ∞ | 1.2000 | | |

TABLE 34
Example 9

| | |
|---|---|
| f | 17.46 |
| Bf | 11.36 |
| FNo. | 2.06 |
| 2ωm[°] | 79.0 |

TABLE 35
Example 9

| Variable | | Short |
|---|---|---|
| surface | Infinite | distance |
| spacing | distance | (97.123 mm) |
| DD[6] | 5.2298 | 2.1724 |
| DD[17] | 2.5005 | 5.5579 |

TABLE 36
Example 9

| Sn | 1 | 2 | 16 | 17 |
|---|---|---|---|---|
| KA | 1.0000000E+00 | 1.0000000E+00 | 1.0000000E+00 | 1.0000000E+00 |
| A4 | −1.9816433E−04 | −3.6297292E−04 | 4.1182368E−06 | 2.0474906E−04 |
| A6 | 9.1484041E−06 | 1.2822204E−05 | 2.6537632E−06 | 3.1246815E−06 |
| A8 | −2.8217901E−07 | −5.2198468E−07 | 1.6658657E−09 | 1.0979096E−07 |
| A10 | 4.8677460E−09 | 4.9742274E−10 | 2.6241075E−09 | −1.6066772E−09 |
| A12 | −5.0970276E−11 | 7.4037697E−10 | 8.7547900E−12 | 1.0497195E−10 |
| A14 | 1.2729316E−12 | −2.8648681E−11 | −3.3545052E−12 | −2.3539978E−12 |
| A16 | −4.0996176E−14 | 3.9725922E−13 | 4.5257307E−14 | −2.4154842E−14 |
| A18 | 5.9805572E−16 | −1.7929358E−16 | −4.3073775E−16 | 3.6486424E−16 |
| A20 | −3.1228853E−18 | −3.0247503E−17 | 5.3383537E−18 | 4.3620323E−18 |

### Example 10

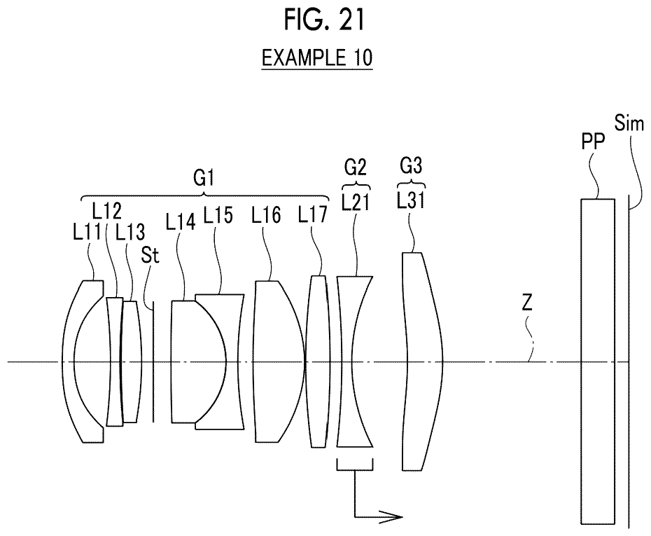

A cross-sectional view of a configuration of an imaging lens according to Example 10 is shown in FIG. 21. The imaging lens according to Example 10 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, lenses L11 to L13, an aperture stop St, and lenses L14 to L17. The second lens group G2 consists of one lens, that is, the lens L21. The third lens group G3 consists of one lens, that is, the lens L31. The focusing group consists of only the second lens group G2. During focusing from the infinite distance object to the short distance object, the focusing group moves to the image side along the optical axis Z.

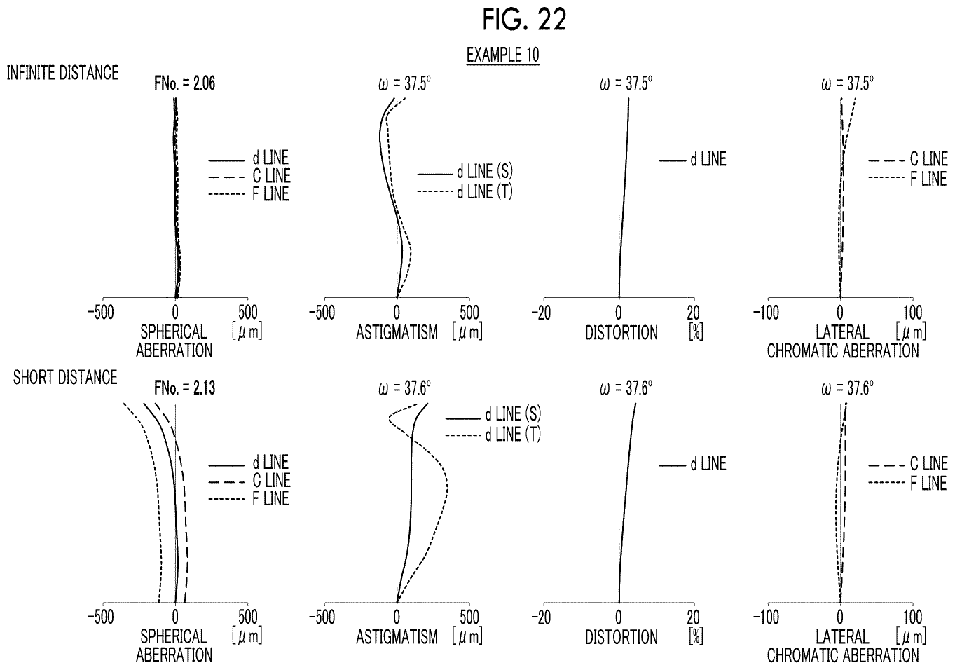

For the imaging lens of Example 10, Table 37 shows basic lens data, Table 38 shows specifications, Table 39 shows a variable surface spacing, Table 40 shows an aspherical coefficient, and FIG. 22 shows each aberration diagram.

TABLE 37
Example 10

| Sn | R | D | Nd | νd |
|---|---|---|---|---|
| *1 | 24.9656 | 1.0025 | 1.51633 | 64.06 |
| *2 | 10.0070 | 3.0981 | | |
| 3 | −44.2701 | 0.8098 | 1.67270 | 32.10 |
| 4 | 54.6579 | 0.1041 | | |
| 5 | 76.0170 | 1.7367 | 2.05091 | 26.95 |
| 6 | −28.8249 | 0.9998 | | |
| 7(St) | ∞ | 1.5000 | | |
| 8 | 176.6709 | 4.6780 | 1.49700 | 81.61 |
| 9 | −6.4894 | 1.0100 | 1.62004 | 36.26 |
| 10 | 31.4066 | 1.2982 | | |
| *11 | 73.9875 | 4.3810 | 1.85135 | 40.10 |
| *12 | −10.8569 | 0.1001 | | |
| 13 | 53.6377 | 2.0203 | 1.85033 | 42.70 |
| 14 | −73.3529 | DD[14] | | |
| 15 | −64.1544 | 0.8498 | 1.78472 | 25.68 |
| 16 | 15.6425 | DD[16] | | |
| *17 | −26.8818 | 2.9974 | 1.72903 | 54.04 |
| *18 | −15.5426 | 11.7905 | | |
| 19 | ∞ | 2.8500 | 1.51680 | 64.20 |
| 20 | ∞ | 1.2000 | | |

TABLE 38
Example 10

| | |
|---|---|
| f | 18.05 |
| Bf | 14.87 |
| FNo. | 2.06 |
| 2ωm[°] | 75.0 |

TABLE 39
Example 10

| Variable | | Short |
|---|---|---|
| surface | Infinite | distance |
| spacing | distance | (83.059 mm) |
| DD[14] | 0.9989 | 2.2026 |
| DD[16] | 4.7358 | 3.5321 |

TABLE 40
Example 10

| Sn | 1 | 2 | 11 | 12 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.1429624E−03 | 1.7739745E−03 | −1.5175943E−05 | 8.9451817E−05 |
| A5 | −8.2849671E−05 | −6.9075414E−04 | −1.3464374E−06 | 8.0153088E−06 |
| A6 | −2.6255769E−05 | 3.7020903E−04 | 1.0496350E−07 | −3.1999195E−06 |
| A7 | 5.7574205E−06 | −1.2643833E−04 | −3.8761945E−08 | 3.6839558E−07 |
| A8 | −5.2234417E−07 | 2.3385835E−05 | 2.6972805E−09 | −6.9120374E−09 |
| A9 | 2.5897459E−08 | −2.1726830E−06 | 5.1002081E−11 | −1.7131737E−09 |
| A10 | −8.0264974E−10 | 7.8305451E−08 | −3.0015377E−12 | 9.6576791E−11 |

| Sn | 17 | 18 |
|---|---|---|
| KA | 1.0000000E+00 | 1.0000000E+00 |
| A3 | 0.0000000E+00 | 0.0000000E+00 |
| A4 | 2.4683429E−04 | 2.3283533E−04 |
| A5 | 5.5415712E−06 | −1.3056173E−05 |
| A6 | −1.1273600E−06 | 2.3392979E−06 |
| A7 | −6.0754634E−08 | −1.2466594E−07 |
| A8 | 1.4010401E−09 | −7.1414761E−09 |
| A9 | 1.9386815E−11 | 7.4693840E−11 |
| A10 | −6.5863420E−13 | 6.0498976E−12 |

### Example 11

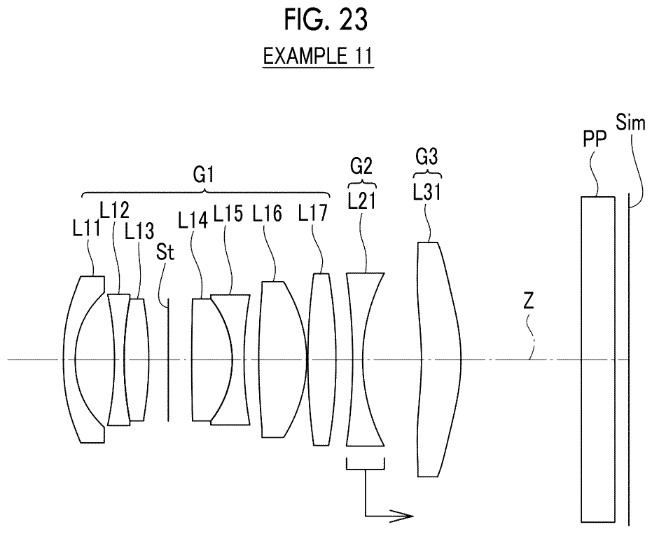

A cross-sectional view of a configuration of an imaging lens according to Example 11 is shown in FIG. 23. The imaging lens according to Example 11 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, lenses L11 to L13, an aperture stop St, and lenses L14 to L17. The second lens group G2 consists of one lens, that is, the lens L21. The third lens group G3 consists of one lens, that is, the lens L31. The focusing group consists of only the second lens group G2. During focusing from the infinite distance object to the short distance object, the focusing group moves to the image side along the optical axis Z.

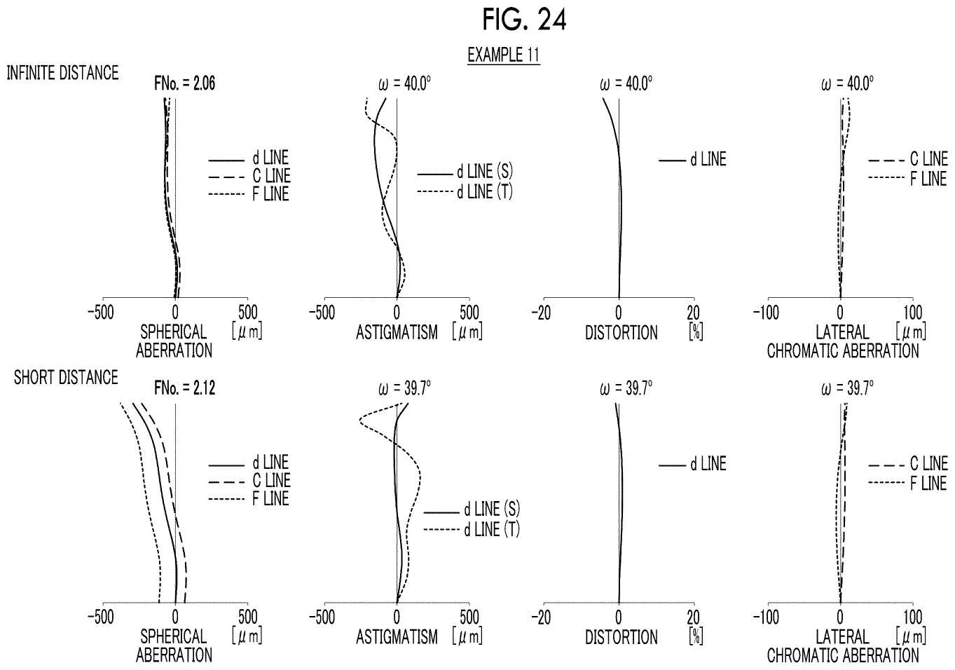

For the imaging lens of Example 11, Table 41 shows basic lens data, Table 42 shows specifications, Table 43 shows a variable surface spacing, Table 44 shows an aspherical coefficient, and FIG. 24 shows each aberration diagram.

TABLE 41
Example 11

| Sn | R | D | Nd | νd |
|---|---|---|---|---|
| *1 | 27.2883 | 1.0002 | 1.51633 | 64.06 |
| *2 | 9.7300 | 3.3455 | | |
| 3 | −27.1481 | 0.8202 | 1.54814 | 45.82 |
| 4 | 27.6671 | 2.0994 | 1.95375 | 32.32 |
| 5 | −29.0306 | 1.6561 | | |
| 6(St) | ∞ | 1.9903 | | |
| 7 | 175.7706 | 3.4508 | 1.49700 | 81.61 |
| 8 | −8.4015 | 1.0000 | 1.67270 | 32.10 |
| 9 | 31.1388 | 1.2546 | | |
| *10 | 56.9387 | 4.0799 | 1.80337 | 45.49 |
| *11 | −11.5298 | 0.1000 | | |
| 12 | 53.7615 | 2.3374 | 1.88300 | 40.76 |
| 13 | −43.4926 | DD[13] | | |
| 14 | −50.9582 | 0.8501 | 1.77047 | 29.74 |
| 15 | 15.6408 | DD[15] | | |
| *16 | −28.5918 | 3.3643 | 1.76842 | 49.28 |
| *17 | −16.0411 | 10.2381 | | |
| 18 | ∞ | 2.8500 | 1.51680 | 64.20 |
| 19 | ∞ | 1.2000 | | |

TABLE 42
Example 11

| | |
|---|---|
| f | 17.66 |
| Bf | 13.33 |
| FNo. | 2.06 |
| 2ωm[°] | 80.0 |

TABLE 43
Example 11

| Variable | | Short |
|---|---|---|
| surface | Infinite | distance |
| spacing | distance | (80.540 mm) |
| DD[13] | 1.4207 | 2.6317 |
| DD[15] | 5.0000 | 3.7890 |

TABLE 44
Example 11

| Sn | 1 | 2 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 9.5398064E−04 | 1.5075489E−03 | −2.6792752E−05 | 7.7572897E−05 |
| A5 | −1.0416702E−04 | −7.0867537E−04 | −3.5473749E−07 | 3.9781159E−06 |
| A6 | −2.0288585E−05 | 3.7598209E−04 | 1.9135658E−07 | −2.4430263E−06 |
| A7 | 5.9091552E−06 | −1.2628027E−04 | −4.0141525E−08 | 4.8712714E−07 |
| A8 | −5.9218432E−07 | 2.3286712E−05 | 2.5338722E−09 | −3.0703266E−08 |
| A9 | 2.5844319E−08 | −2.1719809E−06 | 5.2850219E−11 | −2.9784529E−09 |
| A10 | −4.3847383E−10 | 7.9404176E−08 | −2.9087086E−12 | 3.4506796E−10 |

| Sn | 16 | 17 |
|---|---|---|
| KA | 1.0000000E+00 | 1.0000000E+00 |
| A3 | 0.0000000E+00 | 0.0000000E+00 |
| A4 | 2.3567881E−04 | 2.2450529E−04 |
| A5 | 6.6471872E−06 | −1.2163801E−05 |
| A6 | −1.0417937E−06 | 2.2365597E−06 |
| A7 | −6.1844218E−08 | −1.2185741E−07 |
| A8 | 1.1827909E−09 | −6.8103017E−09 |
| A9 | 1.9887850E−11 | 7.2368797E−11 |
| A10 | −4.8423538E−13 | 5.8170440E−12 |

### Example 12

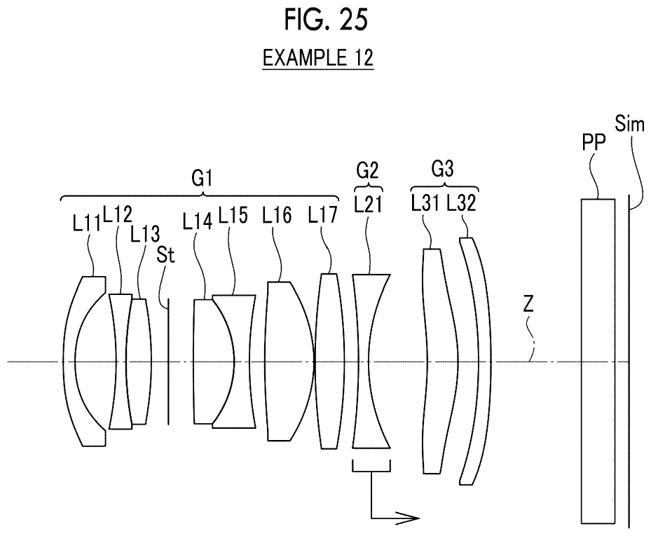

A cross-sectional view of a configuration of an imaging lens according to Example 12 is shown in FIG. 25. The imaging lens according to Example 12 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, lenses L11 to L13, an aperture stop St, and lenses L14 to L17. The second lens group G2 consists of one lens, that is, the lens L21. The third lens group G3 consists of, in order from the object side to the image side, two lenses, that is, lenses L31 and L32. The focusing group consists of only the second lens group G2. During focusing from the infinite distance object to the short distance object, the focusing group moves to the image side along the optical axis Z.

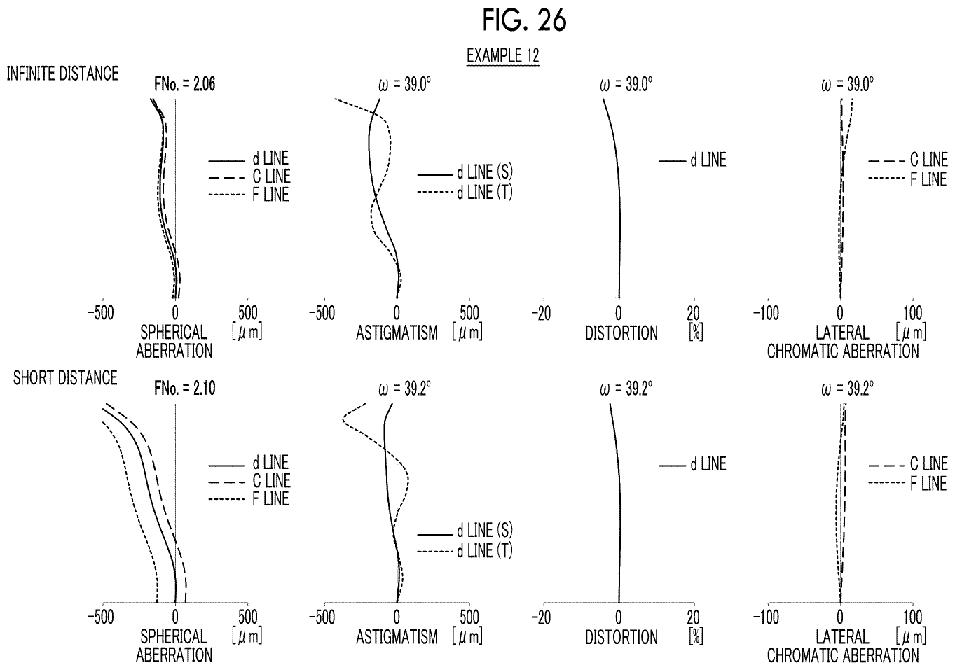

For the imaging lens of Example 12, Table 45 shows basic lens data, Table 46 shows specifications, Table 47 shows a variable surface spacing, Table 48 shows an aspherical coefficient, and FIG. 26 shows each aberration diagram.

TABLE 45
Example 12

| Sn | R | D | Nd | νd |
|---|---|---|---|---|
| *1 | 28.2013 | 1.0012 | 1.51633 | 64.06 |
| *2 | 10.4135 | 3.4913 | | |
| 3 | −27.5636 | 0.8436 | 1.54814 | 45.82 |
| 4 | 28.3315 | 2.1502 | 1.95375 | 32.32 |
| 5 | −28.7141 | 1.4538 | | |
| 6(St) | ∞ | 2.1167 | | |
| 7 | 172.2301 | 3.4745 | 1.49700 | 81.61 |
| 8 | −8.5509 | 1.2936 | 1.67270 | 32.10 |
| 9 | 30.7873 | 1.3027 | | |
| *10 | 58.1216 | 4.1824 | 1.80337 | 45.49 |
| *11 | −11.5897 | 0.0998 | | |
| 12 | 51.1057 | 2.4374 | 1.88300 | 40.76 |
| 13 | −42.3367 | DD[13] | | |
| 14 | −54.4629 | 0.8518 | 1.77047 | 29.74 |
| 15 | 15.7530 | DD[15] | | |
| *16 | −26.1759 | 2.6086 | 1.76842 | 49.28 |
| *17 | −15.8715 | 1.7444 | | |
| *18 | −36.3687 | 1.0549 | 1.51633 | 64.06 |
| *19 | −57.0450 | 7.6987 | | |
| 20 | ∞ | 2.8500 | 1.51680 | 64.20 |
| 21 | ∞ | 1.2000 | | |

TABLE 46
Example 12

| | |
|---|---|
| f | 18.32 |
| Bf | 10.78 |
| FNo. | 2.06 |
| 2ωm[°] | 78.0 |

TABLE 47
Example 12

| Variable | | Short |
|---|---|---|
| surface | Infinite | distance |
| spacing | distance | (83.181 mm) |
| DD[13] | 1.2013 | 2.3821 |
| DD[15] | 4.9998 | 3.8190 |

TABLE 48
Example 12

| Sn | 1 | 2 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.0107936E−03 | 1.5715590E−03 | −2.7703441E−05 | 6.7111930E−05 |
| A5 | −9.3706020E−05 | −6.9125032E−04 | −1.1168719E−06 | 6.0345201E−06 |
| A6 | −2.1778496E−05 | 3.7395372E−04 | 1.6439006E−07 | −2.4407615E−06 |
| A7 | 5.7625510E−06 | −1.2647337E−04 | −4.0647444E−08 | 4.2363589E−07 |
| A8 | −5.6683866E−07 | 2.3326912E−05 | 2.6031804E−09 | −2.6518543E−08 |
| A9 | 2.6372496E−08 | −2.1708040E−06 | 5.3640826E−11 | −2.4349489E−09 |
| A10 | −5.9403489E−10 | 7.9116787E−08 | −2.9746899E−12 | 2.7596159E−10 |
| Sn | 16 | 17 | 18 | 19 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 2.2973484E−04 | 2.2033350E−04 | −8.9737743E−06 | −8.6666540E−06 |
| A5 | 8.7199788E−06 | −6.9034649E−06 | −1.2284268E−06 | −3.3096446E−06 |
| A6 | −9.3332932E−07 | 2.2568307E−06 | 1.0571940E−07 | −1.3901957E−07 |
| A7 | −6.5215144E−08 | −1.2917153E−07 | −1.1508961E−09 | 4.2323307E−09 |
| A8 | 9.4700227E−10 | −6.8497293E−09 | −2.2336768E−10 | 3.9740245E−10 |
| A9 | 2.1693236E−11 | 7.6039737E−11 | 8.7553607E−13 | −3.1303733E−12 |
| A10 | −3.2142288E−13 | 5.8180550E−12 | 1.5506312E−13 | −3.0375548E−13 |

### Example 13

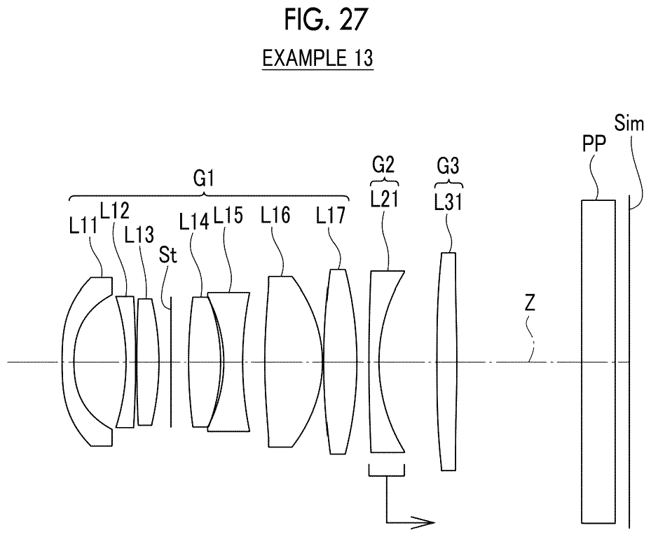

A cross-sectional view of a configuration of an imaging lens according to Example 13 is shown in FIG. 27. The imaging lens according to Example 13 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, lenses L11 to L13, an aperture stop St, and lenses L14 to L17. The second lens group G2 consists of one lens, that is, the lens L21. The third lens group G3 consists of one lens, that is, the lens L31. The focusing group consists of only the second lens group G2. During focusing from the infinite distance object to the short distance object, the focusing group moves to the image side along the optical axis Z.

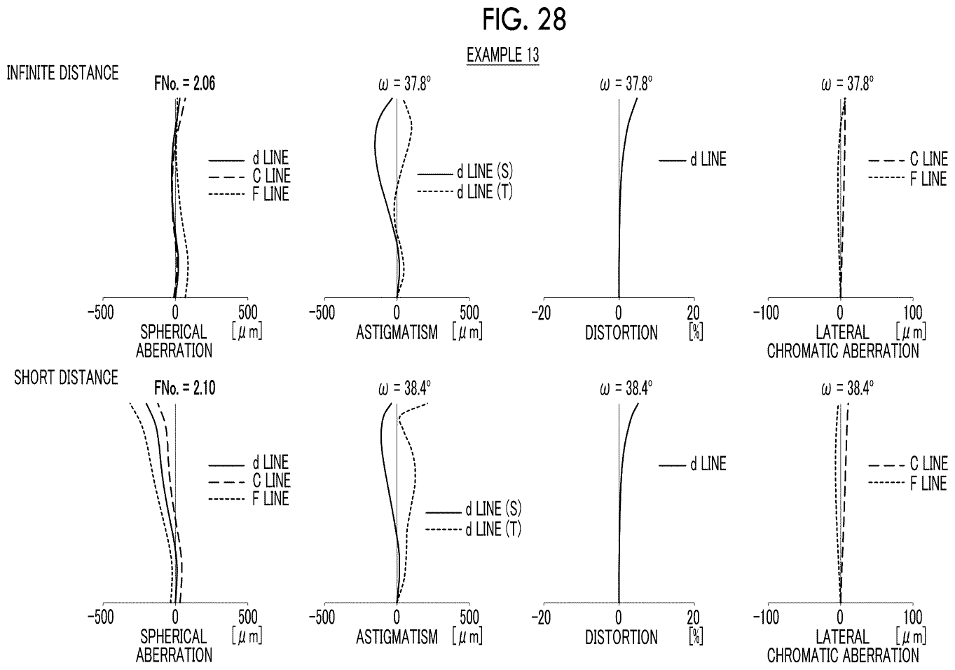

For the imaging lens of Example 13, Table 49 shows basic lens data, Table 50 shows specifications, Table 51 shows a variable surface spacing, Table 52 shows an aspherical coefficient, and FIG. 28 shows each aberration diagram.

TABLE 49
Example 13

| Sn | R | D | Nd | νd |
|---|---|---|---|---|
| *1 | 43.9606 | 0.9998 | 1.51633 | 64.06 |
| *2 | 11.3436 | 4.4356 | | |
| 3 | −18.5166 | 0.8098 | 1.75520 | 27.51 |
| 4 | −92.5678 | 0.1002 | | |
| 5 | 115.6705 | 1.8890 | 2.05091 | 26.95 |
| 6 | −23.2637 | 1.0185 | | |
| 7(St) | ∞ | 1.4998 | | |
| 8 | 42.7389 | 2.7216 | 1.49700 | 81.61 |
| 9 | −15.3748 | 0.2698 | | |
| 10 | −11.9556 | 1.6007 | 1.67270 | 32.10 |
| 11 | 29.9287 | 1.8779 | | |
| *12 | 48.6769 | 4.9084 | 1.72903 | 54.04 |
| *13 | −10.7072 | 0.1001 | | |
| 14 | 59.3634 | 2.7756 | 1.49700 | 81.61 |
| 15 | −31.7055 | DD[15] | | |
| 16 | 169.8036 | 0.8502 | 1.73800 | 32.33 |
| 17 | 14.5282 | DD[17] | | |
| *18 | 339.2404 | 1.6969 | 1.72903 | 54.04 |
| *19 | −102.5572 | 10.5925 | | |
| 20 | ∞ | 2.8500 | 1.51680 | 64.20 |
| 21 | ∞ | 1.2000 | | |

TABLE 50
Example 13

| | |
|---|---|
| f | 17.45 |
| Bf | 13.67 |
| FNo. | 2.06 |
| 2ωm[°] | 75.6 |

TABLE 51
Example 13

| Variable | | Short |
|---|---|---|
| surface | Infinite | distance |
| spacing | distance | (79.023 mm) |
| DD[15] | 1.0247 | 2.6363 |
| DD[17] | 4.9268 | 3.3152 |

TABLE 52
Example 13

| Sn | 1 | 2 | 12 | 13 |
|---|---|---|---|---|
| KA | 1.0000000E+00 | 1.0000000E+00 | 1.0000000E+00 | 1.0000000E+00 |
| A3 | −6.8877590E−19 | 2.3656829E−17 | 0.0000000E+00 | −1.1363628E−19 |
| A4 | 1.7268197E−03 | 2.4874456E−03 | −7.1897088E−05 | 7.1357480E−05 |
| A5 | −6.3240582E−05 | −7.0901453E−04 | 2.9687095E−06 | 1.0003691E−05 |
| A6 | −5.4930914E−05 | 3.5926827E−04 | −1.3275781E−07 | −2.9802312E−06 |
| A7 | 9.7078731E−06 | −1.2305918E−04 | −1.4620335E−08 | 3.5485234E−07 |
| A8 | −5.1290180E−07 | 2.2992982E−05 | 1.5773407E−09 | 9.9447773E−09 |
| A9 | −9.5335361E−10 | −2.1719108E−06 | 3.1951666E−11 | −5.4909871E−09 |
| A10 | 3.5191299E−10 | 8.7294640E−08 | −1.3467524E−12 | 3.4803854E−10 |

| Sn | 18 | 19 |
|---|---|---|
| KA | 1.0000000E+00 | 1.0000000E+00 |
| A3 | 3.5527137E−19 | 1.7763568E−19 |
| A4 | 7.8544299E−05 | 8.7926577E−05 |
| A5 | 7.5706508E−07 | −6.3276001E−06 |
| A6 | −8.5725981E−07 | 2.6657348E−07 |
| A7 | 1.4605830E−08 | −6.2455180E−09 |
| A8 | 2.3266161E−09 | −1.0466499E−09 |
| A9 | −1.3797232E−11 | 9.1454350E−12 |
| A10 | −1.8093347E−12 | 9.8506893E−13 |

Tables 53 to 55 show the corresponding values of Conditional Expressions (1) to (20), (15A), and (17A) of the imaging lenses according to Examples 1 to 13. Preferable ranges of the conditional expressions may be set using the corresponding values of the examples shown in Tables 53 to 55 as the upper limits and the lower limits of the conditional expressions.

TABLE 53

| Expression | | | | | | |
|---|---|---|---|---|---|---|
| number | | Example 1 | Example 2 | Example 3 | Example 4 | Example 5 |
| (1) | TL/(f × tan ωm) | 3.0464 | 3.0677 | 2.9347 | 2.9840 | 2.9722 |
| (2) | TL × FNo/f | 5.4174 | 5.3999 | 5.4127 | 5.0829 | 5.0833 |
| (3) | f/\|f2\| | 0.7396 | 0.6253 | 0.5706 | 0.7136 | 0.6523 |
| (4) | f/Enp | 3.1701 | 3.4629 | 3.1926 | 3.2233 | 3.1762 |
| (5) | DL12/TL | 0.0514 | 0.0516 | 0.0515 | 0.0676 | 0.0663 |
| (6) | Nsf | 2.0509 | 2.0509 | 1.9537 | 1.9007 | 1.8513 |
| (7) | \|(1 − β2²) × β3²\| | 1.6465 | 1.2077 | 1.0781 | 1.1765 | 1.0439 |
| (8) | N1nave | 1.6122 | 1.6029 | 1.6363 | 1.5961 | 1.6338 |
| (9) | Bf/(f × tan ωm) | 0.7146 | 0.7854 | 0.7376 | 0.7283 | 0.7292 |
| (10) | DG2/TL | 0.3183 | 0.3103 | 0.2900 | 0.2657 | 0.2862 |
| (11) | Nmax | 2.0509 | 2.0509 | 1.9537 | 1.9108 | 1.8513 |
| (12) | Npave | 1.6953 | 1.7731 | 1.7511 | 1.7394 | 1.7240 |
| (13) | f/fL1 | −0.7503 | −0.7946 | −0.6729 | −0.7560 | −0.8946 |
| (14) | Exp/(f × tan ωm) | −2.1568 | −2.3970 | −2.2056 | −2.8813 | −2.5622 |
| (15), (15A) | f/f1 | 0.5232 | 0.5376 | 0.6539 | 0.5786 | 0.4593 |
| (16) | f2/f3 | −0.7975 | −0.5724 | −0.6505 | −0.4141 | −0.3315 |
| (17), (17A) | f/f3 | −0.5898 | −0.3579 | −0.3712 | −0.2955 | −0.2162 |
| (18) | DG1/TL | 0.3211 | 0.2993 | 0.3183 | 0.3167 | 0.2899 |
| (19) | DG3/TL | 0.0257 | 0.0260 | 0.0261 | 0.0285 | 0.0272 |
| (20) | f/f12 | 1.3857 | 1.2234 | 1.2271 | 1.2293 | 1.1202 |

TABLE 54

| Expression | | | | | | |
|---|---|---|---|---|---|---|
| number | | Example 6 | Example 7 | Example 8 | Example 9 | Example 10 |
| (1) | TL/(f × tan ωm) | 2.6902 | 3.1309 | 3.2553 | 3.3719 | 3.4078 |
| (2) | TL × FNo/f | 5.1019 | 5.3875 | 5.6785 | 5.7289 | 5.3839 |
| (3) | f/\|f2\| | 1.2580 | 1.1212 | 1.1779 | 1.1371 | 1.1319 |
| (4) | f/Enp | 3.2504 | 3.1045 | 2.7038 | 2.8943 | 3.2859 |
| (5) | DL12/TL | 0.0512 | 0.0673 | 0.0761 | 0.0668 | 0.0657 |
| (6) | Nsf | 1.9611 | 1.8308 | 1.7888 | 1.7888 | 2.0509 |
| (7) | \|(1 − β2²) × β3²\| | 1.5252 | 1.1662 | 1.4458 | 1.2648 | 3.1032 |
| (8) | N1nave | 1.7984 | 1.7404 | 1.8259 | 1.8317 | 1.6030 |
| (9) | Bf/(f × tan ωm) | 0.5632 | 0.7358 | 0.7572 | 0.7897 | 1.0738 |
| (10) | DG2/TL | 0.3178 | 0.3062 | 0.2869 | 0.2963 | 0.0180 |
| (11) | Nmax | 2.0000 | 2.0000 | 2.0000 | 2.0000 | 2.0509 |
| (12) | Npave | 1.7927 | 1.6694 | 1.7513 | 1.7199 | 1.7957 |
| (13) | f/fL1 | −1.2171 | −1.2386 | −1.1758 | −1.2216 | −0.5455 |
| (14) | Exp/(f × tan ωm) | −1.8930 | −2.2436 | −2.3585 | −2.8096 | −4.0441 |
| (15), (15A) | f/f1 | −0.6129 | −0.4865 | −0.5059 | −0.5007 | 1.9031 |
| (16) | f2/f3 | −0.4018 | −0.1932 | −0.2453 | −0.1371 | −0.3508 |
| (17), (17A) | f/f3 | −0.5055 | −0.2166 | −0.2889 | −0.1559 | 0.3971 |
| (18) | DG1/TL | 0.1374 | 0.1446 | 0.1684 | 0.1475 | 0.4818 |
| (19) | DG3/TL | 0.1097 | 0.1133 | 0.1115 | 0.1110 | 0.0635 |
| (20) | f/f12 | 1.3787 | 1.1845 | 1.3045 | 1.2311 | 0.7200 |

TABLE 55

| Expression | | Example | Example | Example |
|---|---|---|---|---|
| number | | 11 | 12 | 13 |
| (1) | TL/(f × tan ωm) | 3.1756 | 3.1754 | 3.4820 |
| (2) | TL × FNo/f | 5.4935 | 5.2948 | 5.5700 |
| (3) | f/\|f2\| | 1.1434 | 1.1615 | 0.8089 |
| (4) | f/Enp | 2.8510 | 2.9284 | 2.7758 |
| (5) | DL12/TL | 0.0710 | 0.0741 | 0.0940 |
| (6) | Nsf | 1.9537 | 1.9537 | 2.0509 |
| (7) | \|(1 − β2²) × β3²\| | 3.0264 | 3.2266 | 2.2796 |
| (8) | N1nave | 1.5791 | 1.5791 | 1.6481 |
| (9) | Bf/(f × tan ωm) | 0.8985 | 0.7268 | 1.0091 |
| (10) | DG2/TL | 0.0180 | 0.0181 | 0.0180 |
| (11) | Nmax | 1.9537 | 1.9537 | 2.0509 |
| (12) | Npave | 1.7811 | 1.7811 | 1.7006 |
| (13) | f/fL1 | −0.5913 | −0.5621 | −0.5833 |
| (14) | Exp/(f × tan ωm) | −3.7021 | −3.1413 | −3.0560 |
| (15), (15A) | f/f1 | 1.8898 | 1.9787 | 1.7433 |
| (16) | f2/f3 | −0.3627 | −0.2514 | −0.1994 |
| (17), (17A) | f/f3 | 0.4146 | 0.2920 | 0.1613 |
| (18) | DG1/TL | 0.4912 | 0.5065 | 0.5301 |
| (19) | DG3/TL | 0.0714 | 0.1149 | 0.0360 |
| (20) | f/f12 | 0.7383 | 0.8299 | 0.8715 |

Although the imaging lenses according to Examples 1 to 13 has a compact configuration, the F-number is less than 2.1, and various aberrations are satisfactorily corrected to maintain high optical performance.

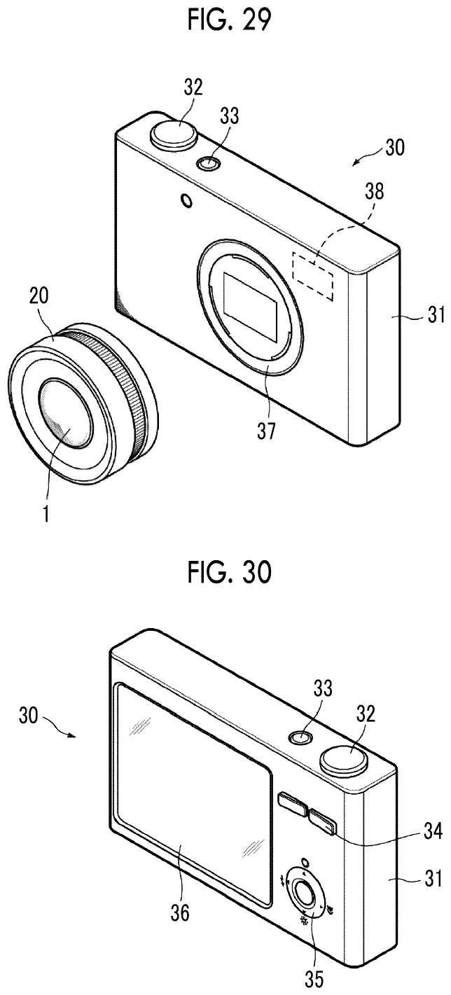

Hereinafter, an imaging apparatus according to the embodiment of the present disclosure will be described. FIGS. 29 and 30 illustrate external views of a camera 30 that is the imaging apparatus according to the embodiment of the present disclosure. FIG. 29 shows a perspective view of the camera 30 viewed from the front surface side, and FIG. 30 shows a perspective view of the camera 30 viewed from the rear surface side. The camera 30 is a so-called mirrorless type digital camera in which an interchangeable lens 20 can be attachably and detachably mounted. The interchangeable lens 20 includes an imaging lens 1 according to the embodiment of the present disclosure accommodated in a lens barrel.

The camera 30 comprises a camera body 31. An upper surface of the camera body 31 is provided with a shutter button 32 and a power button 33. A rear surface of the camera body 31 is provided with an operation unit 34, an operation unit 35, and a display unit 36. The display unit 36 can display the captured image and an image within an angle of view before capturing.

An imaging aperture on which light from an imaging target is incident is provided at a center portion of a front surface of the camera body 31. A mount 37 is provided at a position corresponding to the imaging aperture, and the interchangeable lens 20 is mounted in the camera body 31 via the mount 37.

An imaging element 38 is provided inside the camera body 31. The imaging element 38 outputs an imaging signal corresponding to the subject image formed by the interchangeable lens 20. As the imaging element 38, for example, a charge-coupled device (CCD) or a complementary-metal-oxide semiconductor (CMOS) is used. A signal processing circuit (not shown), a recording medium (not shown), and the like are provided inside the camera body 31. The signal processing circuit generates the image by processing the imaging signal output from the imaging element 38. The recording medium is used for recording the generated image. In the camera 30, a still image or a moving image can be captured by pressing the shutter button 32, and the image data obtained by this capturing is recorded on the recording medium.

While the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example and can have various aspects of, for example, a camera of a type other than a mirrorless type, a film camera, a video camera, and a security camera.

The following supplementary notes are further disclosed with respect to the embodiment and the examples described above.

### Supplementary Note 1

An imaging lens consisting of, in order from an object side to an image side, a first lens group, a second lens group, and a third lens group, in which during focusing, the first lens group and the third lens group are fixed with respect to an image plane and the second lens group moves along an optical axis, a stop that is fixed with respect to the image plane during focusing is disposed on the object side with respect to the second lens group, the first lens group includes a first negative lens of which an image side surface is a concave surface, at a position closest to the object side, and in a case in which a sum of a distance, on the optical axis, from a lens surface of the first lens group closest to the object side to a lens surface of the third lens group closest to the image side and a back focus of an entire system at an air conversion distance, in a state in which an infinite distance object is in focus, is denoted by TL, a focal length of the entire system in a state in which the infinite distance object is in focus is denoted by f, a maximum half angle of view in a state in which the infinite distance object is in focus is denoted by ωm, and an open F-number in a state in which the infinite distance object is in focus is denoted by FNo, Conditional Expressions (1) and (2) are satisfied, which are represented by 2<TL/(f×tan ωm) <5.5(1), and 4<TL×FNo/f<7.5 (2).

### Supplementary Note 2

The imaging lens according to supplementary note 1, in which in a case in which a focal length of the second lens group is denoted by f2, Conditional Expression (3) is satisfied, which is represented by 0.2<f/|f2|<3 (3).

### Supplementary Note 3

The imaging lens according to supplementary note 1 or 2, in which in a case in which a distance, on the optical axis, from a lens surface of the imaging lens closest to the object side to a paraxial entrance pupil position in a state in which the infinite distance object is in focus is denoted by Enp, Conditional Expression (4) is satisfied, which is represented by 1.5<f/Enp <6 (4).

### Supplementary Note 4

The imaging lens according to any one of supplementary notes 1 to 3, in which at least one of the first negative lens of the first lens group or a lens disposed adjacent to the image side of the first negative lens includes an aspherical surface, and in a case in which an air spacing, on the optical axis, between the first negative lens of the first lens group and the lens disposed adjacent to the image side of the first negative lens is denoted by DL12, Conditional Expression (5) is satisfied, which is represented by 0.015<DL12/TL<0.25 (5).

### Supplementary Note 5

The imaging lens according to any one of supplementary notes 1 to 4, in which a positive lens is disposed adjacent to the object side of the stop, and in a case in which a refractive index of the positive lens disposed adjacent to the object side of the stop at a d line is denoted by Nsf, Conditional Expression (6) is satisfied, which is represented by 1.7<Nsf<2.2 (6).

### Supplementary Note 6

The imaging lens according to any one of supplementary notes 1 to 5, in which in a case in which a lateral magnification of the second lens group in a state in which the infinite distance object is in focus is denoted by β2, and a lateral magnification of the third lens group in a state in which the infinite distance object is in focus is denoted by β3, Conditional Expression (7) is satisfied, which is represented by 0.8<| (1-22)× 32|<5 (7).

### Supplementary Note 7

The imaging lens according to any one of supplementary notes 1 to 6, in which the first lens group includes at least two negative lenses and at least one positive lens.

### Supplementary Note 8

The imaging lens according to any one of supplementary notes 1 to 7, in which in a case in which an average value of refractive indexes of all negative lenses included in the first lens group at a d line is denoted by N1nave, Conditional Expression (8) is satisfied, which is represented by 1.555<N1nave <1.9 (8).

### Supplementary Note 9

The imaging lens according to any one of supplementary notes 1 to 8, in which in a case in which the back focus of the entire system at the air conversion distance in a state in which the infinite distance object is in focus is denoted by Bf, Conditional Expression (9) is satisfied, which is represented by 0.4<Bf/(f×tan ωm)<2.5 (9).

### Supplementary Note 10

The imaging lens according to any one of supplementary notes 1 to 9, in which in a case in which a thickness of the second lens group on the optical axis is denoted by DG2, Conditional Expression (10) is satisfied, which is represented by 0.01<DG2/TL<0.4 (10).

### Supplementary Note 11

The imaging lens according to any one of supplementary notes 1 to 10, in which in a case in which a maximum value of refractive indexes of all lenses included in the imaging lens at a d line is denoted by Nmax, Conditional Expression (11) is satisfied, which is represented by 1.8<Nmax<2.2 (11).

### Supplementary Note 12

The imaging lens according to any one of supplementary notes 1 to 11, in which in a case in which an average value of refractive indexes of all positive lenses included in the imaging lens at a d line is denoted by Npave, Conditional Expression (12) is satisfied, which is represented by 1.64<Npave <1.88 (12).

### Supplementary Note 13

The imaging lens according to any one of supplementary notes 1 to 12, in which in a case in which a focal length of the first negative lens of the first lens group is denoted by fL1, Conditional Expression (13) is satisfied, which is represented by−2<f/fL1<−0.45 (13).

### Supplementary Note 14

The imaging lens according to any one of supplementary notes 1 to 13, in which in a case in which a distance, on the optical axis, from the image plane to a paraxial exit pupil position in a state in which the infinite distance object is in focus is denoted by Exp, a sign of Exp is defined such that, with the image plane as a reference, a distance in a direction from the image plane to the object side is negative and a distance in a direction from the object side to the image side is positive, and in a case in which an optical member having no refractive power is disposed between the image plane and the paraxial exit pupil position, Exp is calculated using an air conversion distance for the optical member, Conditional Expression (14) is satisfied, which is represented by−5<Exp/(f×tan @m)<−1.4 (14).

### Supplementary Note 15

The imaging lens according to any one of supplementary notes 1 to 14, in which the second lens group has a positive refractive power, the third lens group has a negative refractive power, and in a case in which a focal length of the first lens group is denoted by f1, Conditional Expression (15) is satisfied, which is represented by−1.5<f/f1<1.5 (15).

### Supplementary Note 16

The imaging lens according to any one of supplementary notes 1 to 15, in which the second lens group has a positive refractive power, the third lens group has a negative refractive power, and in a case in which a focal length of the second lens group is denoted by f2, and a focal length of the third lens group is denoted by f3, Conditional Expression (16) is satisfied, which is represented by−1.1<f2/f3<−0.07 (16).

### Supplementary Note 17

The imaging lens according to any one of supplementary notes 1 to 16, in which the second lens group has a positive refractive power, the third lens group has a negative refractive power, and in a case in which a focal length of the third lens group is denoted by f3, Conditional Expression (17) is satisfied, which is represented by−1.1<f/f3<−0.03 (17).

### Supplementary Note 18

The imaging lens according to any one of supplementary notes 1 to 14, in which the second lens group has a negative refractive power, the third lens group has a positive refractive power, and in a case in which a focal length of the first lens group is denoted by f1, Conditional Expression (15A) is satisfied, which is represented by 1<f/f1<3 (15A).

### Supplementary Note 19

The imaging lens according to any one of supplementary notes 1 to 14 and 18, in which the second lens group has a negative refractive power, the third lens group has a positive refractive power, and in a case in which a focal length of the third lens group is denoted by f3, Conditional Expression (17A) is satisfied, which is represented by 0.1<f/f3<0.7 (17A).

### Supplementary Note 20

An imaging apparatus comprising the imaging lens according to any one of supplementary notes 1 to 19.

What is claimed is:

1. An imaging lens consisting of, in order from an object side to an image side, a first lens group, a second lens group, and a third lens group,
wherein during focusing, the first lens group and the third lens group are fixed with respect to an image plane and the second lens group moves along an optical axis,
a stop that is fixed with respect to the image plane during focusing is disposed on the object side with respect to the second lens group,
the first lens group includes a first negative lens of which an image side surface is a concave surface, at a position closest to the object side, and
in a case in which
a sum of a distance, on the optical axis, from a lens surface of the first lens group closest to the object side to a lens surface of the third lens group closest to the image side and a back focus of the imaging lens at an air conversion distance, in a state in which an infinite distance object is in focus, is denoted by TL,
a focal length of the imaging lens in a state in which the infinite distance object is in focus is denoted by f,
a maximum half angle of view in a state in which the infinite distance object is in focus is denoted by ωm, and
an open F-number in a state in which the infinite distance object is in focus is denoted by FNo,
Conditional Expressions (1) and (2) are satisfied, which are represented by
$$2 < TL / ( f \times tan ω m ) < 5.5 , and \qquad ( 1 )$$
$$4 < TL \times FNo / f < 7.5 . \qquad ( 2 )$$

2. The imaging lens according to claim 1,
wherein in a case in which a focal length of the second lens group is denoted by f2,
Conditional Expression (3) is satisfied, which is represented by
$$0.2 < f / \vert f 2 \vert < 3. \qquad ( 3 )$$

3. The imaging lens according to claim 1,
wherein in a case in which a distance, on the optical axis, from a lens surface of the imaging lens closest to the object side to a paraxial entrance pupil position in a state in which the infinite distance object is in focus is denoted by Enp,
Conditional Expression (4) is satisfied, which is represented by
$$1.5 < f / Enp < 6. \qquad ( 4 )$$

4. The imaging lens according to claim 1,
wherein at least one of the first negative lens of the first lens group or a lens disposed adjacent to the image side of the first negative lens includes an aspherical surface, and
in a case in which an air spacing, on the optical axis, between the first negative lens of the first lens group and the lens disposed adjacent to the image side of the first negative lens is denoted by DL12,
Conditional Expression (5) is satisfied, which is represented by
$$0.015 < DL 12 / TL < 0.25 . \qquad ( 5 )$$

5. The imaging lens according to claim 1,
wherein a positive lens is disposed adjacent to the object side of the stop, and
in a case in which a refractive index of the positive lens disposed adjacent to the object side of the stop at a d line is denoted by Nsf,
Conditional Expression (6) is satisfied, which is represented by
$$1.7 < Nsf < 2.2 . \qquad ( 6 )$$

6. The imaging lens according to claim 1,
wherein in a case in which
a lateral magnification of the second lens group in a state in which the infinite distance object is in focus is denoted by β2, and
a lateral magnification of the third lens group in a state in which the infinite distance object is in focus is denoted by β3,
Conditional Expression (7) is satisfied, which is represented by
$$0.8 < \vert ( 1 - β {2}^{2} ) \times β {3}^{2} \vert < 5. \qquad ( 7 )$$

7. The imaging lens according to claim 1,
wherein the first lens group includes at least two negative lenses and at least one positive lens.

8. The imaging lens according to claim 1,
wherein in a case in which an average value of refractive indexes of all negative lenses included in the first lens group at a d line is denoted by N1nave,
Conditional Expression (8) is satisfied, which is represented by
$$1.555 < N 1 nave < 1.9 . \qquad ( 8 )$$

9. The imaging lens according to claim 1,
wherein in a case in which the back focus of the imaging lens at the air conversion distance in a state in which the infinite distance object is in focus is denoted by Bf,
Conditional Expression (9) is satisfied, which is represented by
$$0. 4 < Bf / ( f \times tan ω m ) < 2.5 . \qquad ( 9 )$$

10. The imaging lens according to claim 1,
wherein in a case in which a thickness of the second lens group on the optical axis is denoted by DG2,
Conditional Expression (10) is satisfied, which is represented by
$$0.01 < DG 2 / TL < 0.4 . \qquad ( 10 )$$

11. The imaging lens according to claim 1,
wherein in a case in which a maximum value of refractive indexes of all lenses included in the imaging lens at a d line is denoted by Nmax,
Conditional Expression (11) is satisfied, which is represented by
$$1.8 < Nmax < 2.2 . \qquad ( 11 )$$

12. The imaging lens according to claim 1,
wherein in a case in which an average value of refractive indexes of all positive lenses included in the imaging lens at a d line is denoted by Npave,
Conditional Expression (12) is satisfied, which is represented by
$$1.64 < Npave < 1.88 . \qquad ( 12 )$$

13. The imaging lens according to claim 1,
wherein in a case in which a focal length of the first negative lens of the first lens group is denoted by fL1,
Conditional Expression (13) is satisfied, which is represented by
$$- 2 < f / fL 1 < - 0.45 . \qquad ( 13 )$$

14. The imaging lens according to claim 1,
wherein in a case in which
a distance, on the optical axis, from the image plane to a paraxial exit pupil position in a state in which the infinite distance object is in focus is denoted by Exp,
a sign of Exp is defined such that, with the image plane as a reference, a distance in a direction from the image plane to the object side is negative and a distance in a direction from the object side to the image side is positive, and
in a case in which an optical member having no refractive power is disposed between the image plane and the paraxial exit pupil position, Exp is calculated using an air conversion distance for the optical member,
Conditional Expression (14) is satisfied, which is represented by
$$- 5 < Exp / ( f \times tan ω m ) < - 1.4 . \qquad ( 14 )$$

15. The imaging lens according to claim 1,
wherein the second lens group has a positive refractive power,
the third lens group has a negative refractive power, and
in a case in which a focal length of the first lens group is denoted by f1,
Conditional Expression (15) is satisfied, which is represented by
$$- 1.5 < f / f 1 < 1.5 . \qquad ( 15 )$$

16. The imaging lens according to claim 1,
wherein the second lens group has a positive refractive power,
the third lens group has a negative refractive power, and
in a case in which
a focal length of the second lens group is denoted by f2, and
a focal length of the third lens group is denoted by f3,
Conditional Expression (16) is satisfied, which is represented by
$$- 1.1 < f 2 / f 3 < - 0.07 . \qquad ( 16 )$$

17. The imaging lens according to claim 1,
wherein the second lens group has a positive refractive power,
the third lens group has a negative refractive power, and
in a case in which a focal length of the third lens group is denoted by f3,
Conditional Expression (17) is satisfied, which is represented by
$$- 1.1 < f / f 3 < - 0.03 . \qquad ( 17 )$$

18. The imaging lens according to claim 1,
wherein the second lens group has a negative refractive power,
the third lens group has a positive refractive power, and
in a case in which a focal length of the first lens group is denoted by f1,
Conditional Expression (15A) is satisfied, which is represented by
$$1 < f / f 1 < 3. \qquad ( 15 A )$$

19. The imaging lens according to claim 1,
wherein the second lens group has a negative refractive power,
the third lens group has a positive refractive power, and
in a case in which a focal length of the third lens group is denoted by f3,
Conditional Expression (17A) is satisfied, which is represented by
$$0.1 < f / f 3 < 0.7 . \qquad ( 17 A )$$

20. An imaging apparatus comprising:
the imaging lens according to claim 1.
